(19) United States
(12) Patent Application Publication
(10) Pub. No.: US 2016/0005134 A1
(43) Pub. Date: Jan. 7, 2016

(54) COURTING AND DATING TECHNOLOGY

(71) Applicant: Peter Anthony Busch von Gontard, Dallas, TX (US)

(72) Inventor: Peter Anthony Busch von Gontard, Dallas, TX (US)

(73) Assignee: Courtem, LLC, Dallas, TX (US)

(21) Appl. No.: 14/323,917

(22) Filed: Jul. 3, 2014

(51) Int. Cl. G06Q 50/00; G06Q 10/10

(52) U.S. Cl. CPC G06Q 50/01; G06Q 10/109

(57) ABSTRACT

A method of facilitating courting and dating is performed by at least one computing device. The method includes steps of displaying a courtship offer for a date from a first person to a user, acquiring from the user an acceptance of the courtship offer, a rejection of the courtship offer, or a request for a better courtship offer, and transmitting to the first person the acceptance of the courtship offer or the request for a better courtship offer through a communication system or channel. Also, a method from the perspective of the first person. Furthermore, computing devices configured to perform the methods.

### BACKGROUND

The present disclosure generally relates to a mobile technology that facilitates courting and dating.

### SUMMARY

In some aspects, a method of facilitating courting and dating is performed by at least one computing device. The method includes steps of displaying a courtship offer for a date from a first person to a user, acquiring from the user an acceptance of the courtship offer, a rejection of the courtship offer, or a request for a better courtship offer, and transmitting to the first person the acceptance of the courtship offer or the request for a better courtship offer through a communication system or channel.

In a case that the user accepts the courtship offer, the method may further include acquiring an indication from the user of whether or not the user chooses to permit other people to attempt to submit competing courtship offers for a period of time. In a case that the indication is that the user chooses to permit the other people to submit the competing courtship offers for the period of time, the method may further include acquiring an indication of the period of time from the user.

In a case that at least one other person submits at least one competing courtship offer during the period of time, the method may also include displaying the competing courtship offer to the user, acquiring from the user an acceptance of the competing courtship offer, a rejection of the competing courtship offer, or a request for a better competing courtship offer during the period of time, and transmitting to the other person the acceptance of the competing courtship offer or the request for a better competing courtship offer through a communication system or channel.

In a case that the user accepts the competing courtship offer, the method may additionally include transmitting to the first person an indication that their courtship offer has been poached.

The method may additionally include engaging a rating system a predetermined time after a time of the date, and the time for the date may be determined by accessing synced calendars of the user and the first person that indicate the time of the date. Engaging the rating system may be performed by transmitting to the user a request to rate the first person and the user's opinion about the date and acquiring from the user a rating of the first person and the user's opinion about the date.

In a case that the user requests the better courtship offer, the method may also include acquiring a reason for the request for the better courtship offer from the user and transmitting to the first person the reason through the communication system or channel. Acquiring the reason for the request for the better courtship offer may be performed using a scrolling list of preselected responses.

In some aspects, a method of facilitating courting and dating is also performed by at least one computing device. The method includes the steps of displaying a profile of at least a first person within a geographic area corresponding to a user and acquiring from the user an indication of an intention to court the first person or not to court the first person. The user may decide to hold on providing the indication until a later time.

In a case of the indication of the intention to court the first person, the method also includes the steps of acquiring a courtship offer from the user for a date with the first person, transmitting the courtship offer from the user to the first person through the communication system or channel, receiving an acceptance of the courtship offer or a request for a better courtship offer from the first person, and displaying the acceptance of the courtship offer or the request for a better courtship offer to the user. Displaying the profile of the first person may include displaying a rating of the first person.

In a case that the first person has accepted a prior courtship offer from a second person and has chosen to permit other people to attempt to submit competing courtship offers for a period of time, the method may further include displaying the prior courtship offer and a time remaining for the user to submit a competing courtship offer. In a case that the first person accepts the courtship offer, enabling text based chatting between the user and the first person.

The method may additionally include engaging a rating system a predetermined time after a time of the date, and the time for the date may be determined by accessing synced calendars of the user and the first person that indicate the time of the date. Engaging the rating system may be performed by transmitting to the user a request to rate the first person and the user's opinion about the date and acquiring from the user a rating of the first person and the user's opinion about the date.

In some aspects, the method may additionally include acquiring an indication that the first person has accepted a competing courtship offer from a second person, and displaying that the user's courtship offer has been poached.

The subject technology also includes computing devices configured to perform the above methods.

This brief summary has been provided so that the nature of the invention may be understood quickly. Additional steps and/or different steps than those set forth in this summary may be used. A more complete understanding of the invention may be obtained by reference to the following description in connection with the attached drawings.

### BRIEF DESCRIPTION OF THE DRAWINGS

FIG. 1 illustrates an environment including mobile computing devices in which aspects of the subject technology may operate.

FIG. 2 illustrates a flowchart showing part of a courting and dating method from the perspective of a computing device used by a person courting another person according to aspects of the subject technology.

FIG. 3 illustrates a flowchart showing part of a courting and dating method from the perspective of a computing device used by a person being courted according to aspects of the subject technology.

FIG. 4 illustrates a flowchart showing part of a courting and dating method after a user has accepted a courtship offer according to aspects of the subject technology.

FIG. 5 illustrates a flowchart showing part of a courting and dating method involving providing a reason for requesting a better courtship offer according to aspects of the subject technology.

FIG. 6 illustrates a flowchart showing part of a courting and dating method involving rating another person's behavior according to aspects of the subject technology.

FIG. 7 illustrates a mobile computing device showing a push notification according to aspects of the subject technology.

FIG. 8 illustrates a mobile computing device showing a launch screen according to aspects of the subject technology.

FIG. 9 illustrates a mobile computing device showing a profile selection screen according to aspects of the subject technology.

FIG. 10 illustrates a mobile computing device showing a profile screen according to aspects of the subject technology.

FIG. 11 illustrates a mobile computing device showing a “hold” verification screen according to aspects of the subject technology.

FIGS. 12, 13, and 14 illustrate a mobile computing device showing a courting screen according to aspects of the subject technology.

FIG. 15 illustrates a mobile computing device showing a date time proposal screen according to aspects of the subject technology.

FIGS. 16 and 17 illustrate a mobile computing device showing a date offer screen according to aspects of the subject technology.

FIG. 18 illustrates a mobile computing device showing a timer selection pop-up according to aspects of the subject technology.

FIG. 19 illustrates a mobile computing device showing an “up offer” request pop-up according to aspects of the subject technology.

FIG. 20 illustrates a mobile computing device showing a block user confirmation pop-up according to aspects of the subject technology.

FIG. 21 illustrates a mobile computing device showing a main menu screen according to aspects of the subject technology.

FIG. 22 illustrates a mobile computing device showing an accepted courtship offers screen according to aspects of the subject technology.

FIG. 23 illustrates a mobile computing device showing a cancel date pop-up according to aspects of the subject technology.

FIG. 24 illustrates a mobile computing device showing a hold list screen according to aspects of the subject technology.

FIG. 25 illustrates a mobile computing device showing a private policy screen according to aspects of the subject technology.

FIG. 26 illustrates a mobile computing device showing a chat screen according to aspects of the subject technology.

FIG. 27 illustrates a mobile computing device showing a timer management screen according to aspects of the subject technology.

FIG. 28 illustrates a mobile computing device showing a user profile screen according to aspects of the subject technology.

FIG. 29 illustrates a mobile computing device showing an edit profile screen according to aspects of the subject technology.

FIGS. 30 and 31 illustrate a mobile computing device showing date rating pop-ups according to aspects of the subject technology.

### DETAILED DESCRIPTION

Long-gone are the days in which people engaged in “courting” someone in whom they were interested. Whatever happened to bringing flowers on a first date, holding the door open, bringing gifts, going to a nice restaurant, and simply wooing someone? According to statistics, the top two qualities women find attractive in a man are (1) a sense of humor and (2) class, which can be summarized as wealth, a sense of fun, a sense of security, and an ability to spoil a woman. Men likewise find these characteristics attractive in a woman. The same also applies to non-traditional relationships. (For the sake of brevity, the remainder of this disclosure is cast in terms of a man courting a woman. However, the subject technology is equally applicable to any person courting any other person.)

A woman may use an “app” on a mobile phone according to aspects of the subject technology out of curiosity. She may want to see what a man might present to her for the “best date she's ever been on,” to impress her, or to compete over her. It is a curiosity thing! He may not be the most physically attractive suitor she has had, be he might make an attractive courtship offer such as, “I will bring flowers and take you and a friend to the best restaurant in town.”

One issue that may arise in this context is that some people may talk “big” and then fail to deliver. Therefore, aspects of the subject technology include a mechanism for “proving-up” a courtship offer. The mechanism may include a rating system. Namely, after a predetermined time for a date based on an accepted courtship offer, both people may be asked their respective opinions about the date and to provide a rating of the other person. For example, the following day after the date, the woman may receive a message asking her opinion about whether or not the gentleman followed through on his promise. If the answer is “no,” then the man's rating may be affected adversely. Likewise, the man may be asked if the woman showed up. If the answer is “no,” then the woman's rating may be affected adversely. “Yes” answers may affect the people's ratings positively or based on a separate rating such as assigning one to five stars to the other person based on the date.

According to aspects of the subject technology, the woman may not be limited to accepting or rejecting a courtship offer from a man. Instead, she may respond by asking the man to “up” his offer. A variety of reasons for this request may be provided in some selectable form such as a scrolling list, simplifying this process.

An element of competition may be introduced into the courting process according to aspects of the subject technology. Namely, a woman may conditionally accept a courtship offer while allowing other potential suitors to try to beat that offer for a period of time. If the new offer is accepted, the original suitor in turn may be offered the opportunity to re-up the new offer. Alternatively, if the woman likes a courtship offer enough, she may just accept the offer without permitting others to attempt to beat the offer.

The “up offer” and competition aspects of the subject technology may introduce an element of excitement and gaming into the courting and dating process.

Aspects of the subject technology that generally attempt to enable the foregoing courting and dating process are discussed below with respect to the figures. However, the subject technology is not limited to fully enabling all details of that foregoing courting and dating process. Likewise, the subject technology is not limited to the details of the environments and examples shown in the figures and discussed below. Rather, the details are provided for illustrative purposes and to provide context for discussion.

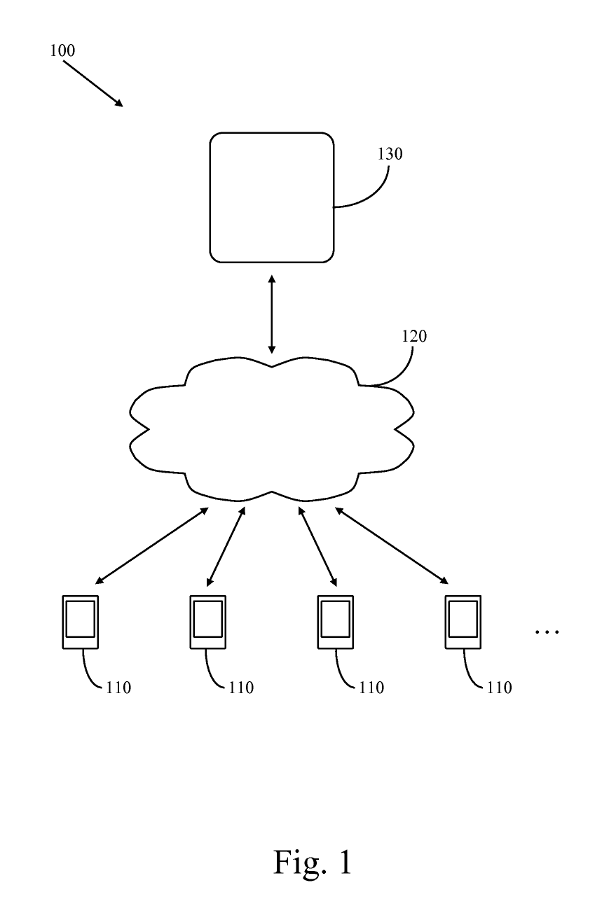

FIG. 1 illustrates an environment including mobile computing devices in which aspects of the subject technology may operate. Environment 100 includes mobile computing devices 110 that communicate with each other over communication system or channel 120. Communication system or channel 120 may be any type of communication system or channel over which computing device 110 may communicate or a combination of such systems and/or channels. Examples of communication system or channel 120 include but are not limited to a mobile phone network, the Internet, WiFi, a BlueTooth® connection (e.g., directly device to device), some combination thereof, and the like.

Examples of mobile computing devices 110 include smart phones and tablet computers. According to aspects of the subject technology, mobile computing devices 110 include one or more tangible computing elements and at least one input/output mechanism such as a touch screen. The subject technology is not limited to computing devices that include a touch screen. For example, interaction via a keyboard, touchpad, mouse, and or voice recognition may be used in some aspects.

In preferred aspects, one or more of the mobile computing devices may also include some mechanism for determining a geographic location or geographic proximity to other mobile computing devices 110. Examples of such a mechanism include but are not limited to a geo-fencing or global positioning satellite (GPS) chip, a mechanism for determining a location from communication system or channel 120 (e.g., sniffing an address from a WiFi or telephone network), and a mechanism for measuring signal strength (e.g., with respect to communication over BlueTooth®).

The mobile computing devices may also communicate with other computing devices such as computing device 130. Examples of the other computing devices may include desktop or laptop computers, web servers, other servers, and any other types of computing devices. Various aspects of the subject technology may be considered to be performed by one or more of mobile computing devices 110, other computing devices such as device 130, or both.

While the subject technology is generally discussed herein in the context of mobile computing devices, the technology is not limited to mobile devices. Rather, aspects of the subject technology may be performed by virtually any type of computing devices that include at least a tangible computing element. Examples of a tangible computing element include but are not limited to a microprocessor, application specific integrated circuit, programmable gate array, and the like. A tangible computing element may operate in one or more of a digital, analog, electric, photonic, and/or some other manner. Examples of a computing device include but are not limited to a mobile computing device such as a smart phone or tablet computer, a wearable computing device (e.g., Google® Glass), a laptop computer, a desktop computer, a server, a client that communicates with a server, a smart television, a game counsel, a part of a cloud computing system, or any other form of computing device. The computing device preferably includes or accesses storage for instructions used to perform techniques discussed herein. As noted above, the computing devices may also include some mechanism for determining a geographic location or geographic proximity to other computing devices.

Additionally, some operations may be considered to be performed by multiple computing devices. For example, steps of displaying may be considered to be performed by both a local computing device and a remote computing device that instructs the local computing device to display something. For another example, steps of acquiring or receiving may be considered to be performed by a local computing device, a remote computing device, or both. Communication between computing devices may be through one or more other computing devices.

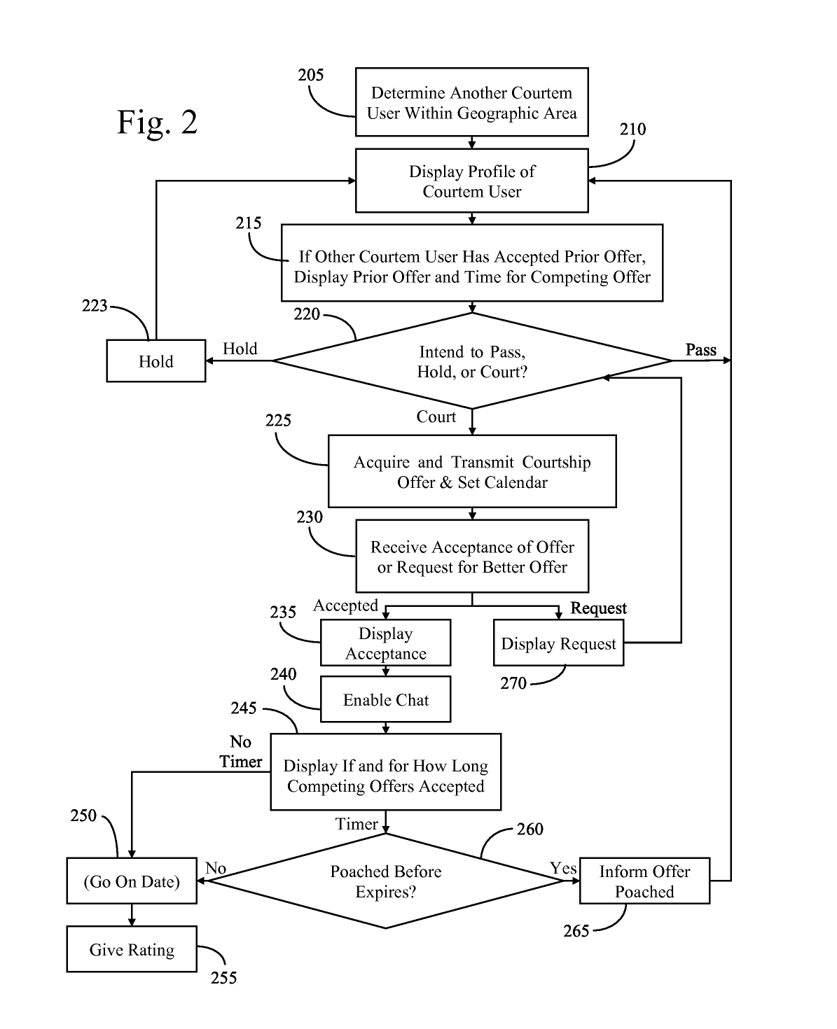

FIG. 2 illustrates a flowchart showing part of a courting and dating method from the perspective of a computing device used by a person courting another person according to aspects of the subject technology.

Briefly, a method of facilitating courting and dating is also performed by at least one computing device according to aspects of the subject technology. The method includes the steps of displaying a profile of at least a first person within a geographic area corresponding to a user and acquiring from the user an indication of an intention to court the first person or not to court the first person. The user may decide to hold on providing the indication until a later time.

In a case of the indication of the intention to court the first person, the method also includes the steps of acquiring a courtship offer from the user for a date with the first person, transmitting the courtship offer from the user to the first person through the communication system or channel, receiving an acceptance of the courtship offer or a request for a better courtship offer from the first person, and displaying the acceptance of the courtship offer or the request for a better courtship offer to the user. Displaying the profile of the first person may include displaying a rating of the first person.

The following discussion is in the context of an “app” running on a mobile computing device. The app is referred to as the “Courtem” app for ease of reference. The subject technology is not limited to this context.

In step 205 in FIG. 2, a preferably mobile computing device determines one or more candidate people for courting by the user. In some aspects, candidates for courting include one or more other people who are Courtem users (or other people who can interact with the app in some manner) within a pre-defined geographic area. In this context, the term “geographic area” may be defined as within a certain distance from the computing device, within a particular city, town, or other region, visiting a particular location such as a restaurant, park, library, museum, or the like, any other geographic area, or some combination thereof. The determination may be made, for example, via location information shared with a web server, other server, or social media (e.g., Facebook, Twitter, Yelp, or the like). A pop-up may be generated on the computing device to inform the user that another user is within that geographic area. Alternatively, some other criteria may be used to identify one or more candidate people for courting by the user.

Profiles of the candidates for courting are displayed to the user by the computing device in step 210, preferably one at a time. The remaining discussion of the method illustrated in FIG. 2 is presented in the context steps that may be performed with respect to one of those candidates.

If the candidate has accepted a courtship offer from someone else and has chosen to permit others to make competing courtship offers, the accepted offer preferably is displayed by the computing device in step 215 along with the profile. A time remaining for the user to “beat” the accepted offer preferably also is displayed.

In step 220, the computing device acquires whether the user wants to pass on courting the candidate, hold on courting the candidate, or court the candidate. If the user wants to pass on courting the candidate, flow proceeds back to step 210 for display of a profile for a next potential candidate for courting if such exists.

In some aspects, step 220 offers the option to “hold” on making a decision whether or not to court—or continue to court—the candidate. If the user chooses to hold on making the decision, flow proceeds to step 223 where the candidate's profile is designated for later review. Flow then proceeds back to step 210 for display of a profile for a next potential candidate for courting if such exists.

If the user wants to court the candidate, flow proceeds to step 220. A courtship offer is acquired from the user and transmitted to the candidate by the computing device over a communication system or channel (or combination thereof) in step 225. In step 230, the computing device receives an acceptance of the courtship offer or a request for a better courtship offer, for example from a computing device used by the candidate over a communication system or channel. The acceptance or request may not be received in real time, but rather after or upon the candidate deciding to accept the offer or request the better offer. Furthermore, if the candidate outright rejects the courtship offer, the computing device may not receive anything from the candidate.

If the courtship offer is accepted, the acceptance is displayed to the user by the computing device in step 235. A chat feature may be enabled in step 240 to permit the users to communicate. Chat may take various forms including but not limited to text chat and video chat.

According to some aspect, the candidate may have permitted others to attempt to make courtship offers better than the accepted offer for a period of time. Whether or not the candidate has permitted others to attempt to make such offers is displayed to the user in step 245, along with how long the candidate will entertain such offers.

If the candidate has not permitted others to attempt to make such offers, the courtship offer has been fully accepted by the candidate. Flow then proceeds to steps 250, during which the user and the candidate go on their date. According to the subject technology, the computing device may do nothing during this time or may facilitate interaction between the user and the candidate, for example through enabling continued chatting. Other actions such as cancelation of the date may also occur during step 250.

A predetermined time after the date, the user and the candidate may be given the opportunity to rate each other's behavior in step 255. One possible technique for rating each other's behavior is explained in more detail below with respect to FIG. 6.

Returning to FIG. 2, if the candidate permitted others to attempt to make a better courtship offer for a period of time, flow proceeds to step 260. If no other courtship offer is accepted by the candidate as being better before the period of time expires, flow proceeds from step 260 to step 250.

If another courtship offer is accepted by the candidate as being better before the period of time expires, flow proceeds from step 260 to step 265. In step 265, the user is informed that his or her previously accepted courtship offer has been “poached.” Flow then proceeds back to step 210 for display of a profile for a next potential candidate for courting if such exists. Alternatively, the flow may proceed to step 220 if the user intends to re-up their poached offer to the candidate.

Returning to step 230, if the candidate requested a better offer from the user, that request is displayed by the computing device to the user in step 270. Flow then proceeds back to step 220, where the user can decide to continue the courting process or to stop.

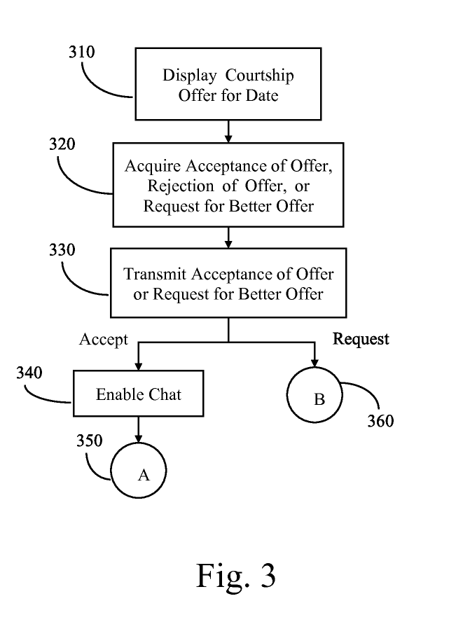

FIG. 3 illustrates a flowchart showing part of a courting and dating method from the perspective of a computing device used by a person being courted according to aspects of the subject technology.

Briefly, a method of facilitating courting and dating is performed by at least one computing device according to aspects of the subject technology. The method includes steps of displaying a courtship offer for a date from a first person to a user, acquiring from the user an acceptance of the courtship offer, a rejection of the courtship offer, or a request for a better courtship offer, and transmitting to the first person the acceptance of the courtship offer or the request for a better courtship offer through a communication system or channel.

In step 310, a courtship offer to a user from another person for a date is shown to the user by a preferably mobile computing device. The computing device may alert the user that the offer has been made via a pop-up, pushed message, or updating an icon displayed by the computing device (e.g., an app icon on a mobile device's home screen), and the user may then request that the offer be displayed. Alternatively, the offer may be displayed automatically.

The device acquires the user's acceptance of the offer, rejection of the offer, or request for a better offer in step 320. Acceptance of the offer or a request for a better offer are transmitted to the other person in step 330. If the user rejects the offer, preferably nothing is sent to the other Courtem user. (Transmission of rejection of the offer may be injurious and hurt the other person's feelings.)

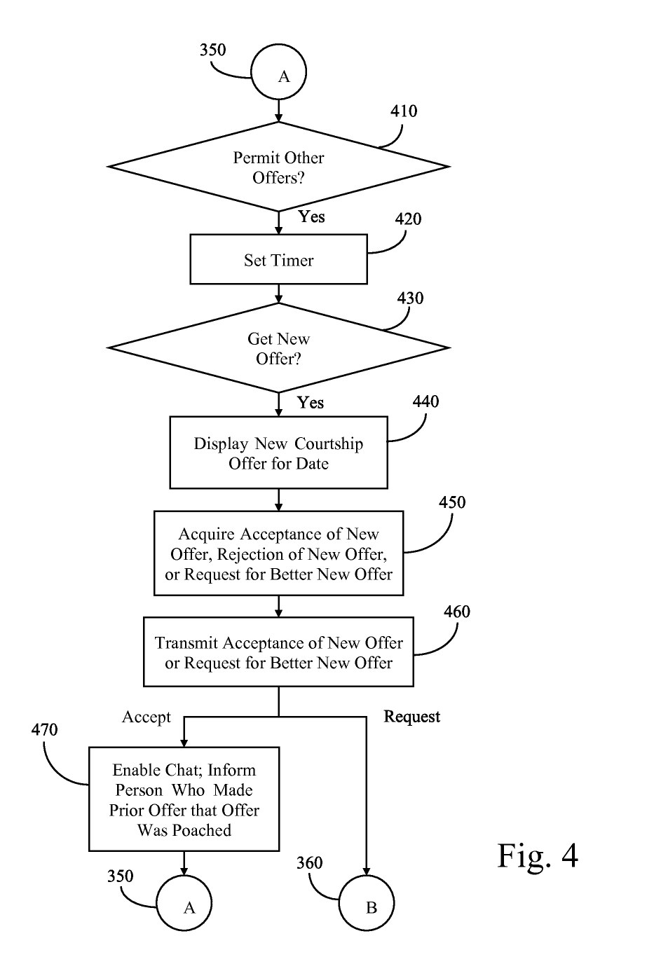

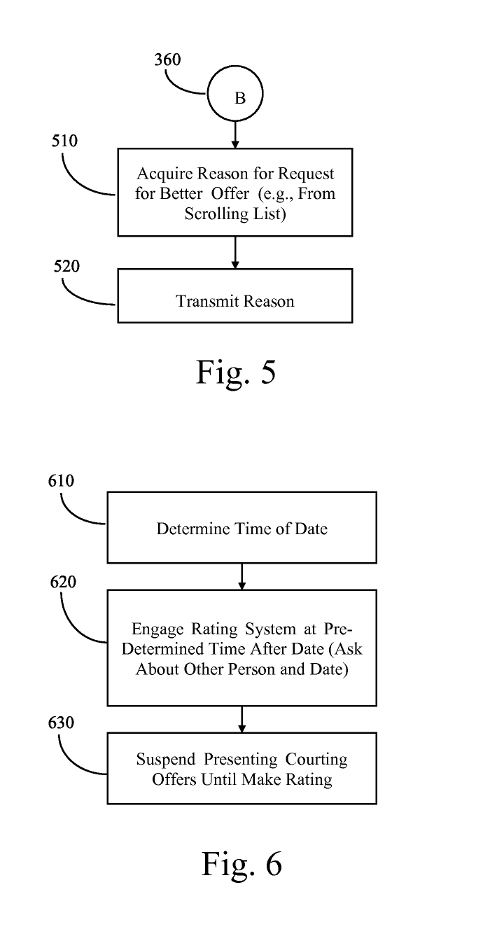

If the user accepted the offer, chat may be enabled in step 340. Flow then proceeds via link A 350 to FIG. 4. If the user requested a better offer, flow proceeds via link B 360 to FIG. 5.

FIG. 4 illustrates a flowchart showing part of a courting and dating method after a user has accepted a courtship offer according to aspects of the subject technology. Flow proceeds from link A 350 to step 410, in which the computing device acquires an indication from the user of whether or not the user chooses to permit other people to attempt to submit competing courtship offers for a period of time. If the user chooses to permit competing offers, a time period for others to make those offers is set in step 420. If the user gets another offer in step 430, the new offer is displayed in step 440. Flow proceeds from step 440 through 470 in a similar manner as steps 310 to 340 in FIG. 3, except that the other person whose accepted offer was poached is informed in step 470.

FIG. 5 illustrates a flowchart showing part of a courting and dating method involving providing a reason for requesting a better courtship offer according to aspects of the subject technology. Flow proceeds from link B 360 to step 510, in which the computing device acquires a reason why the user is requesting a better offer. In some aspects, the computing device provides a scrolling list of predetermined possible reasons from which the user may select the reason. The predetermined possible reasons preferably are selected to inject fun and humor into the “Up Offer” process. The reason is transmitted to the other person by the computing device in step 520.

Additional steps that may be performed according to aspects of the subject technology include but are not limited to automatically adding a reminder for a date to people's local or remote calendars once a courtship offer has been accepted and/or a time for competing courtship offers has expired. The reminder may be automatically deleted if a courtship offer is poached.

FIG. 6 illustrates a flowchart showing part of a courting and dating method involving rating another person's behavior according to aspects of the subject technology. The subject technology is not limited to the rating system illustrated in FIG. 6.

A time of an agreed upon date is determined by the computing device in step 610. This time may be determined by accessing the synced calendars of the people who agreed upon the date. A rating system is engaged in step 620 at a predetermined time after the date. For example, the person who performed the courting may be asked if the other person showed up and for a rating of the other person. For another example, the person who was courted may be asked if the other person performed as promised on their courtship offer and for a rating of the other person. The answers to these inquiries may be used to update the ratings that are shown when others view those people's profiles.

In step 630, presenting courtship offers to at least the person who was courted may be suspended until that person makes his or her rating(s). Thus, rating by at least people who are being courted is encouraged. Alternatively, step 630 may be omitted, and presenting courtship offers may not be suspended.

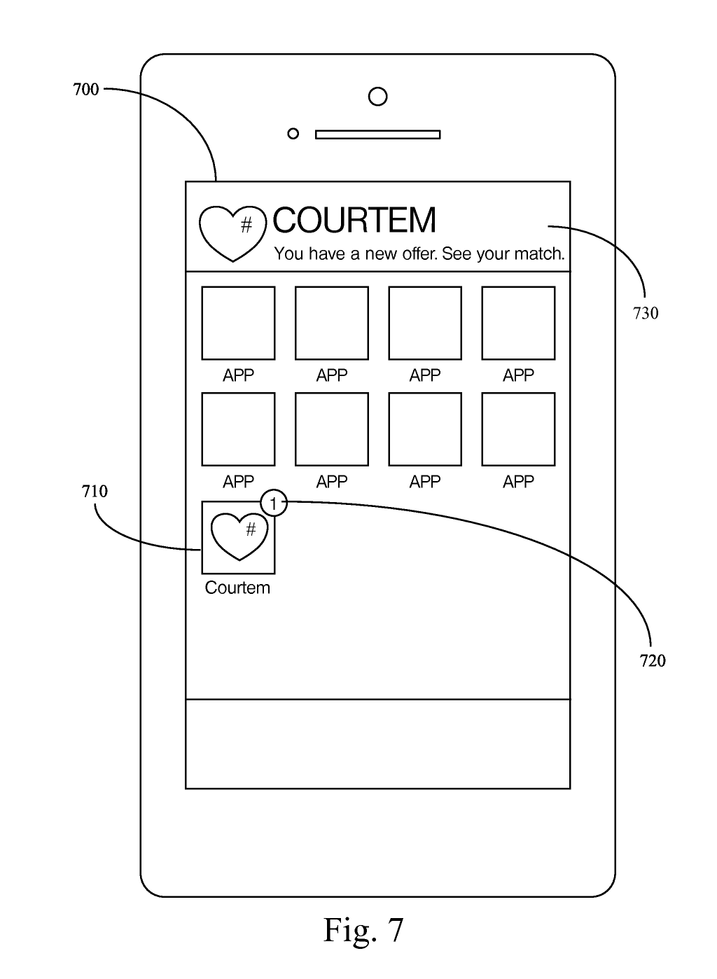

FIG. 7 illustrates a mobile computing device showing a push notification according to aspects of the subject technology. Screen 700 shows a “home” page on the mobile computing device including various icons for “apps.” Icon 710 is for a “Courtem” app. Tapping the icon starts the app. Counter 720 shows a number of un-reviewed courtship offers that have been made to the user, requests to “up” previous courtship offers made by the user, and/or courtship offers poached by another person. If no un-reviewed offers and/or requests have been made, the counter may not be displayed. Alternatively, the counter may also be omitted entirely and shown only internally after accessing the Courtem app. Push notification 730 also shows that a new courtship offer and/or request has recently been made to the user of the Courtem app. Other push notifications, for example that a courtship offer by the user has been accepted and/or poached, may also be displayed.

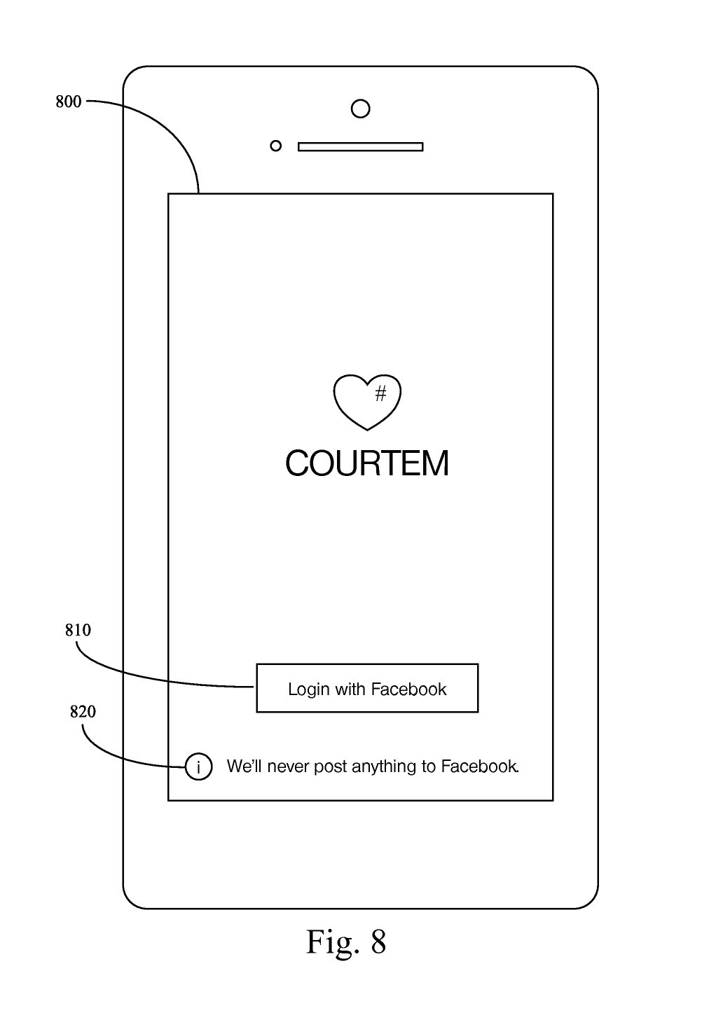

FIG. 8 illustrates a mobile computing device showing a launch screen according to aspects of the subject technology. Screen 800 includes button 810 for logging into the Courtem app through social media, for example Facebook, Twitter, or the like. If the user logs in through social media, various profile information for the user may be accessed via the user's social media profile. Button 820 permits the user to access a brief notice that the subject technology will not be used to post anything to the user's social media account.

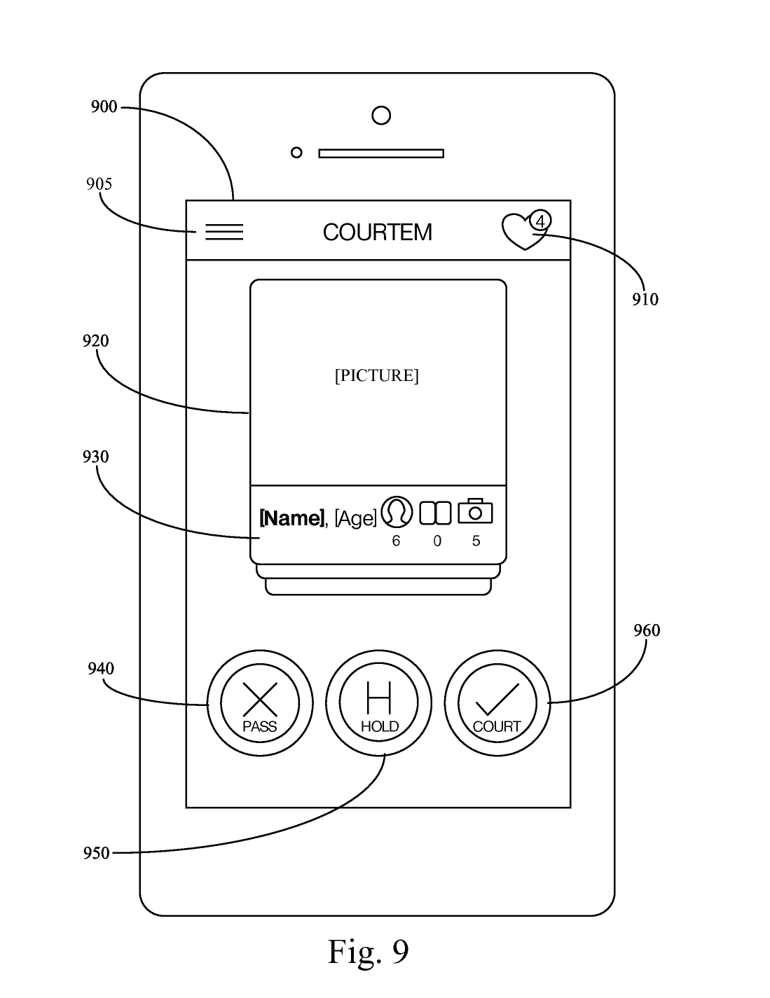

FIG. 9 illustrates a mobile computing device showing a profile selection screen according to aspects of the subject technology. Screen 900 may be displayed upon a user starting the Courtem app. Button 905 may be used to access a main menu for the app. This button may also be shown by the computing device on various other screens. Navigation through the app may be done via the menu button, various standard buttons such as “Back” (not shown in FIG. 9), standard gestures such as taps, touches, and swipes, and the like. In general, such standard interactions with the app are not discussed in detail throughout the rest of this disclosure unless useful for explaining specific functionality.

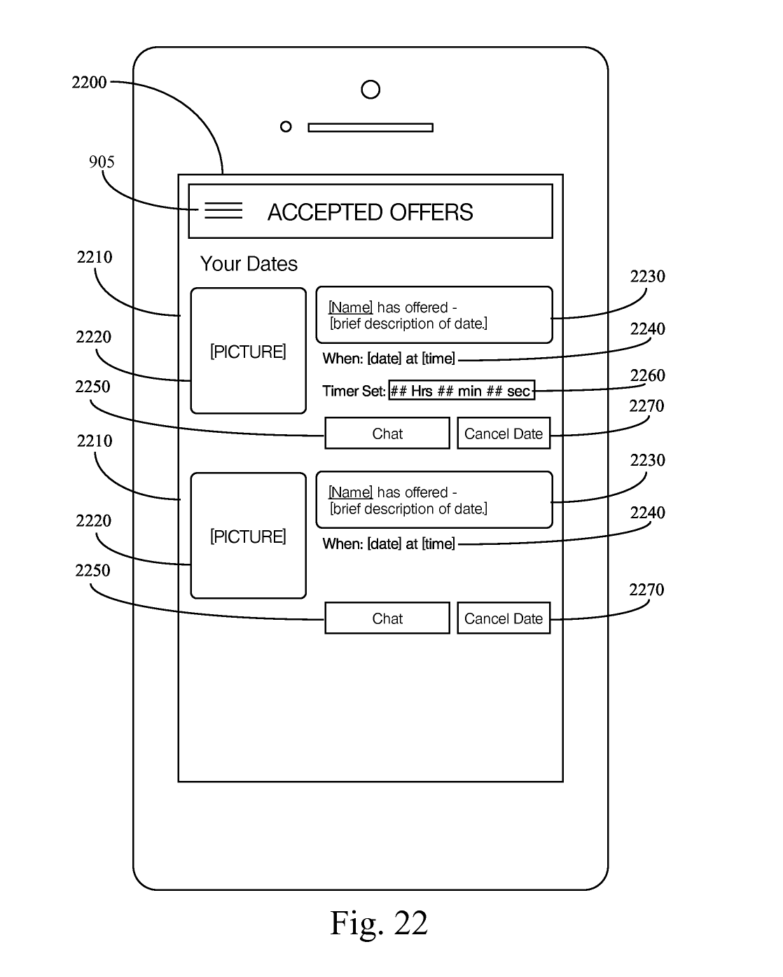

If a courtship offer by the user to another person has been newly accepted, a check mark may appear slightly above and to the right of button 905. The button may also change color in this event to visually notify the user that an offer has been newly accepted. Other types of indicators such as an audio sound may also be used. In some aspects, when an offer has been newly accepted, tapping on button 905 may navigate the user directly to an “Accepted Offers” screen, for example as shown in FIG. 22, instead of to the main menu.

Button 910 may be used to go to a screen showing courtship offers that have been made to the user, requests to “up” previous courtship offers made by the user, and/or courtship offers poached by another person. The counter at the top right of button 910 shows a number of such courtship offers and/or requests that have not yet been reviewed by the user. The button may also change color to visually notify the user about such courtship offers and/or requests. Other types of indicators such as an audio sound may also be used. If no un-reviewed offers and/or requests have been made, the counter may not be displayed.

Picture 920 and basic information 930 may be displayed for a person who has been identified as a candidate for the user to court. The person may be identified by being detected in a particular geographic area or in some other fashion.

The picture 920 and/or basic information may be touched in order to go to a more detailed profile for the person. The user may “Pass” on courting the person using button 940, “Hold” on making a decision about courting a person using button 950, or “Court” the person using button 960. Alternatively, the computing device may detect swiping over picture 920, with swiping left indicating “Pass,” swiping up indicating “Hold,” and swiping right indicating “Court.” If the user indicates that he or she has chosen to court the person, screens for reviewing more information about the person and/or making a courtship offer to the person may be displayed by the computing device. On the other hand, if the user has chosen to hold or pass on courting the person, picture 920 and basic information 930 may be displayed for another person who has been identified as a potential candidate for courting if such exists.

According to aspects of the subject technology, the term “picture” may encompass any visual and/or audio information that a person may place in their profile. For example, in some aspects, a picture may be a still image or a moving image, with or without sound, or even a sound file without any image. In other aspects, restrictions on what is permitted to be used as a “picture” may exist. The picture may be stored locally, remotely such as on a social media site, or in some other fashion.

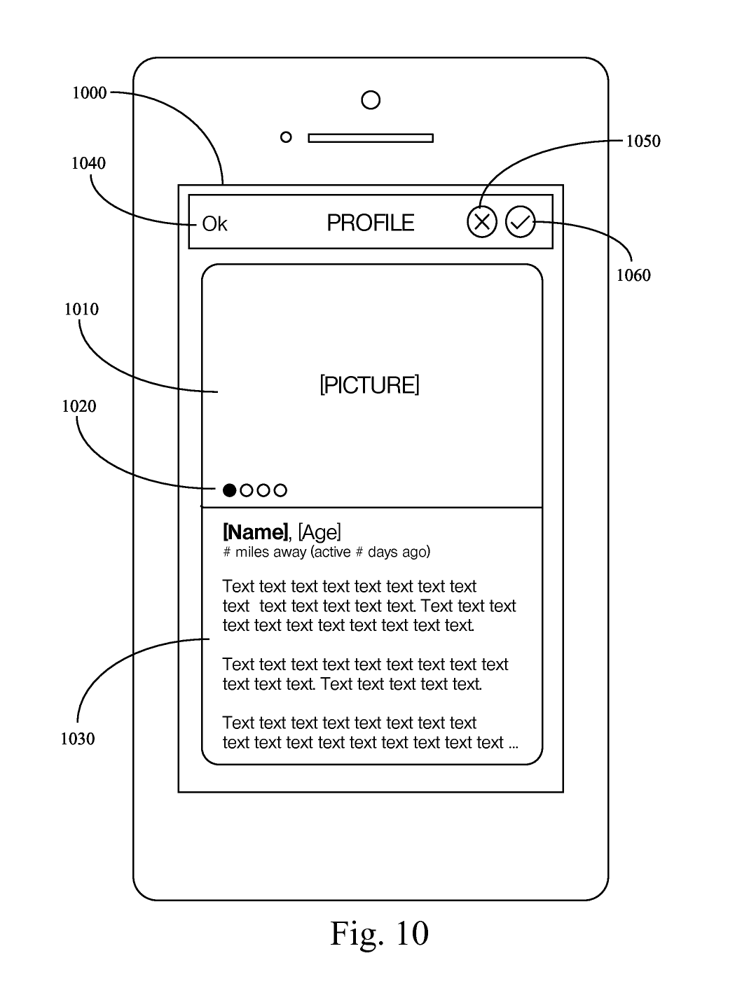

FIG. 10 illustrates a mobile computing device showing a profile screen according to aspects of the subject technology. This screen may be accessed, for example, by the user tapping picture 920 or basic information 930 shown in FIG. 9.

Profile screen 1000 includes one or more profile pictures 1010. Navigation among plural pictures may be accomplished by swiping across a picture. Indicator 1020 shows how may profile pictures are available and which picture is being viewed. In the example shown in FIG. 10, the first of four pictures is being viewed.

Profile screen 1000 also includes more detailed profile information than shown in FIG. 9. For example, the person's name, age, geographic distance from the user, time since last Courtem activity, and profile text is shown in FIG. 10. Other or different information may also be shown. The user may go back to a previously viewed screen using “Ok” button 1040. Alternatively, the user may pass on courting the person using button 1050 or decide to court the person using button 1060 directly from the profile screen.

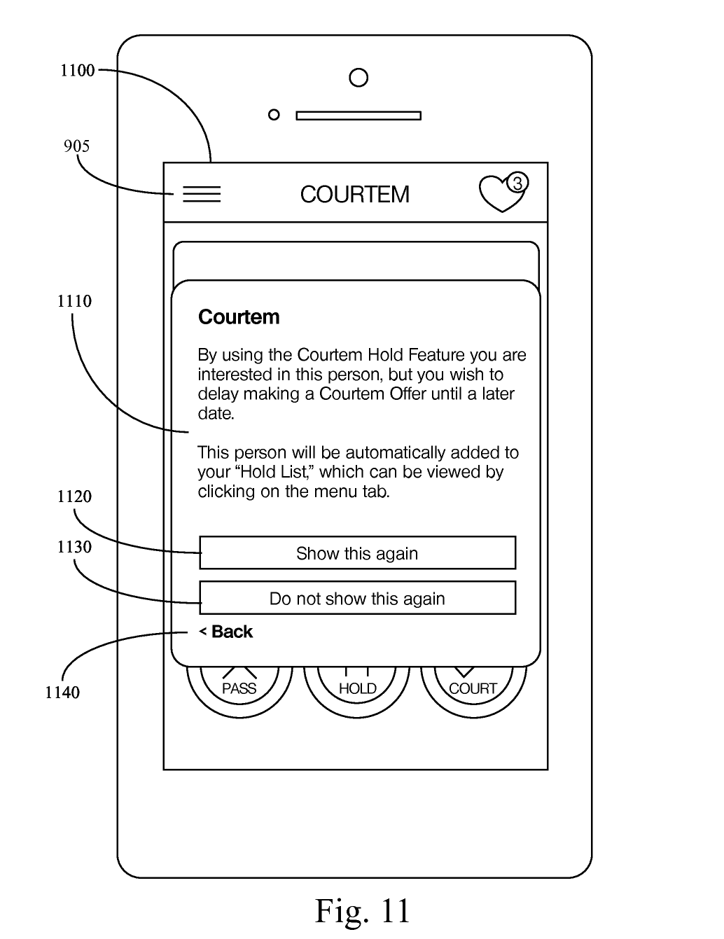

FIG. 11 illustrates a mobile computing device showing a “hold” verification screen according to aspects of the subject technology. Screen 1100 includes a pop-up with explanatory text 1110, “Show this again” button 1120, and “Do not show this again” button 1130. Tapping either of these buttons dismisses the pop-up and effects whether or not the pop-up will be shown the next time the user decides to hold on deciding to court a person. In FIG. 11, “<Back” button 1140 also may be used to dismiss the pop-up.

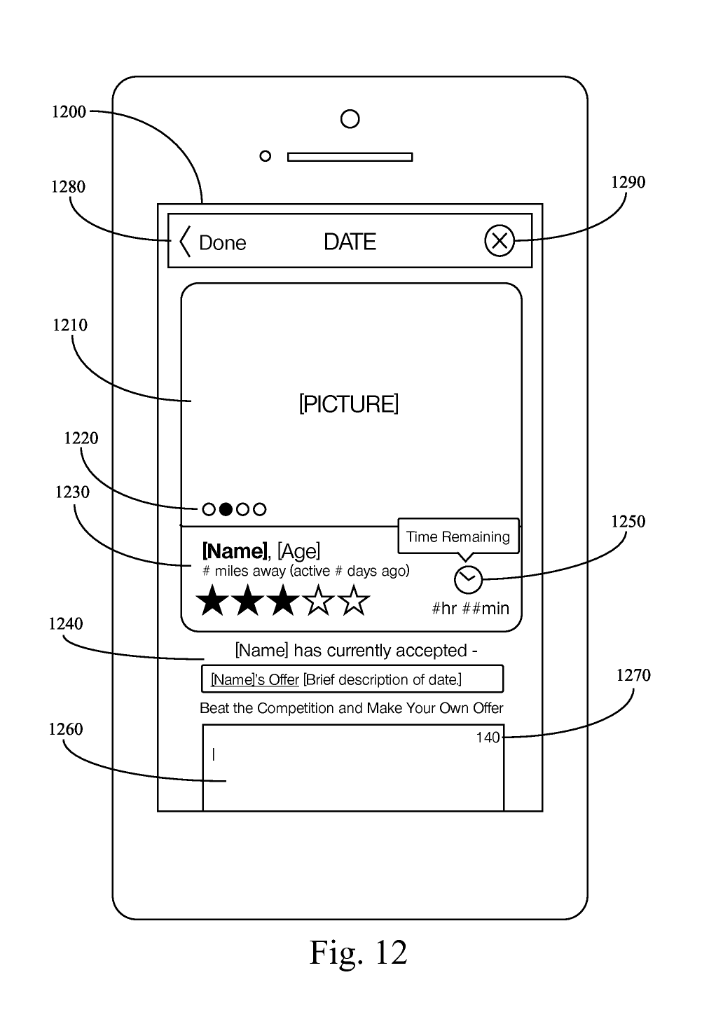

FIGS. 12, 13, and 14 illustrate a mobile computing device showing a courting screen according to aspects of the subject technology. Screen 1200 may be shown if a user has decided to court a person. The screen includes one or more profile pictures 1210. Navigation among plural pictures may be accomplished by swiping across a picture. Indicator 1220 shows how may profile pictures are available and which picture is being viewed. In the example shown in FIG. 10, the second of four pictures is being viewed.

Screen 1200 also shows basic profile information 1230 including the person's name, age, geographic distance from the user, time since last Courtem activity, and a rating for the person. In FIG. 12, the rating is shown as three stars out of five. Other or different information may also be shown.

Indicator 1240 shows basic information about a courtship offer that the person has accepted from another person. Timer 1250 shows how long the user has to attempt to “poach” the accepted offer. Text input box 1260 may be used to describe a courtship offer to the person. In some aspects, the description may be limited to some number of characters. This limitation may enable the offer to be sent to the person being courted via some forms of social media. For example, in FIG. 12, counter 1270 indicates that the courtship offer may contain a maximum of 140 characters. Thus, aspects of the subject technology may send the offer to the person being courted via Twitter.

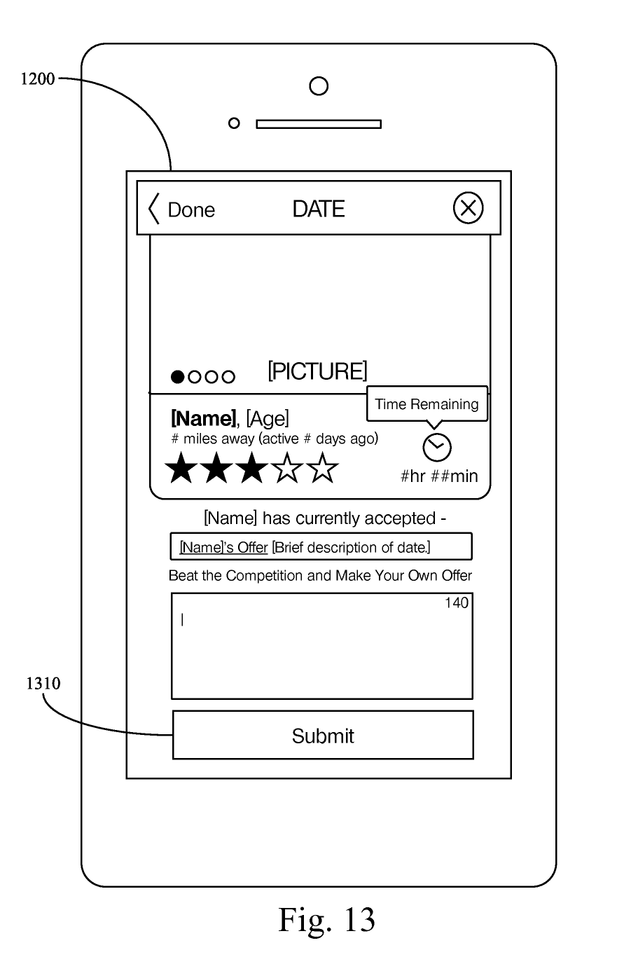

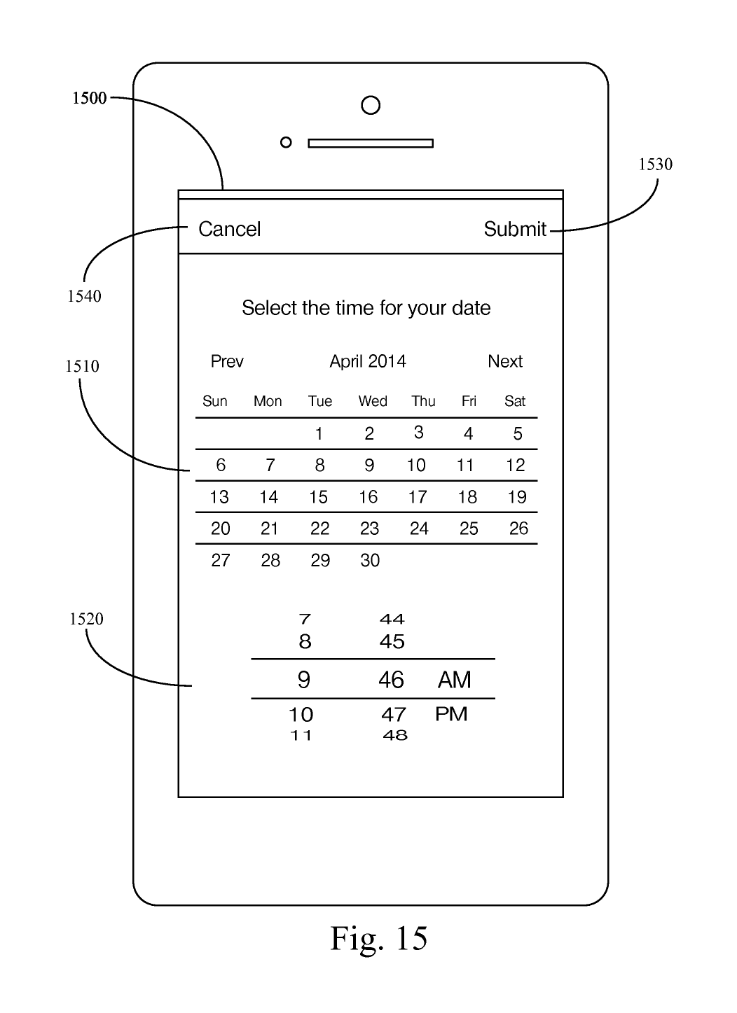

“<Done>” button 1280 and “Cancel” button 1290 may be used to navigate away from screen 1200. The user may also scroll down to show “Submit” button 1310 as shown in FIG. 13. Tapping the submit button navigates the user to a date time proposal screen, for example as shown in FIG. 15.

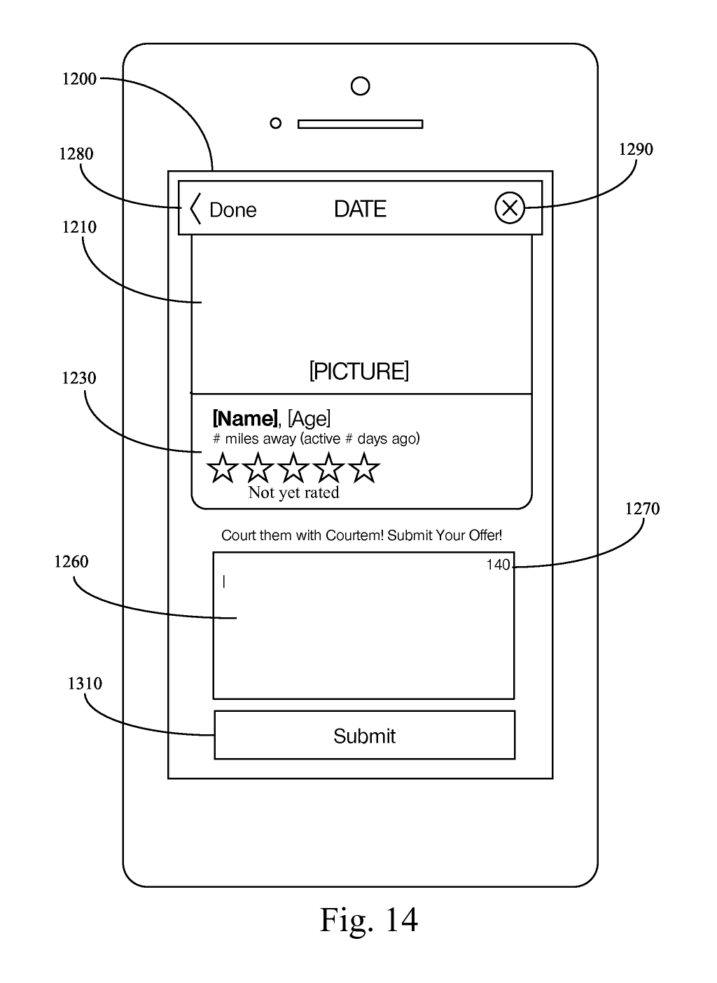

FIG. 14 shows some possible variations on screen 1200 for various reasons. First, the person whose profile is shown in FIG. 14 has only one profile picture, so indicator 1220 is not present. Second, the person has not been rated, as indicated in basic information 1230. Third, the person has not received a courtship offer yet and/or the person has not decided to permit others (such as the user) to attempt to poach an accepted offer. Thus, indicator 1240 (FIG. 12) and timer 1250 (FIG. 12) are not present. Other variations are possible according to aspects of the subject technology.

FIG. 15 illustrates a mobile computing device showing a date time proposal screen according to aspects of the subject technology. Screen 1500 shows calendar 1510 and scrollable time selection area 1520. The user may propose a time and date for their courtship offer using the calendar and scrollable time selection area. For example, if the courtship offer is “dinner and a movie for you and a friend,” the calendar and time selection area may be used to propose a time for the dinner and movie. “Submit” button 1530 may be used to submit the offer to the person being courted. The offer may be canceled using “Cancel” button 1540.

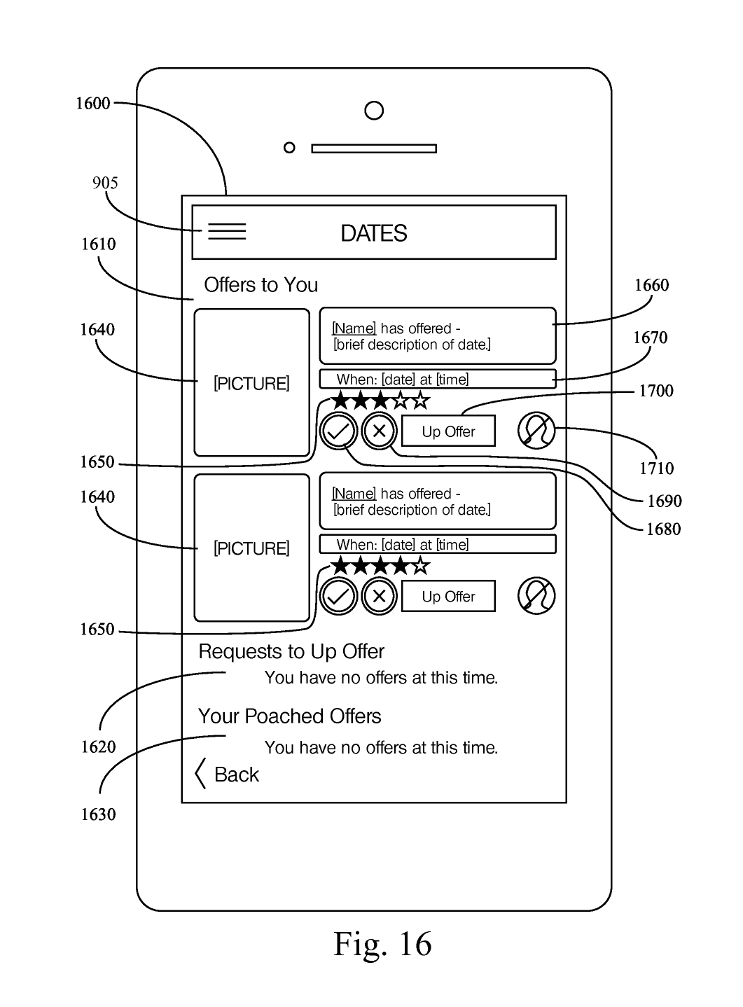

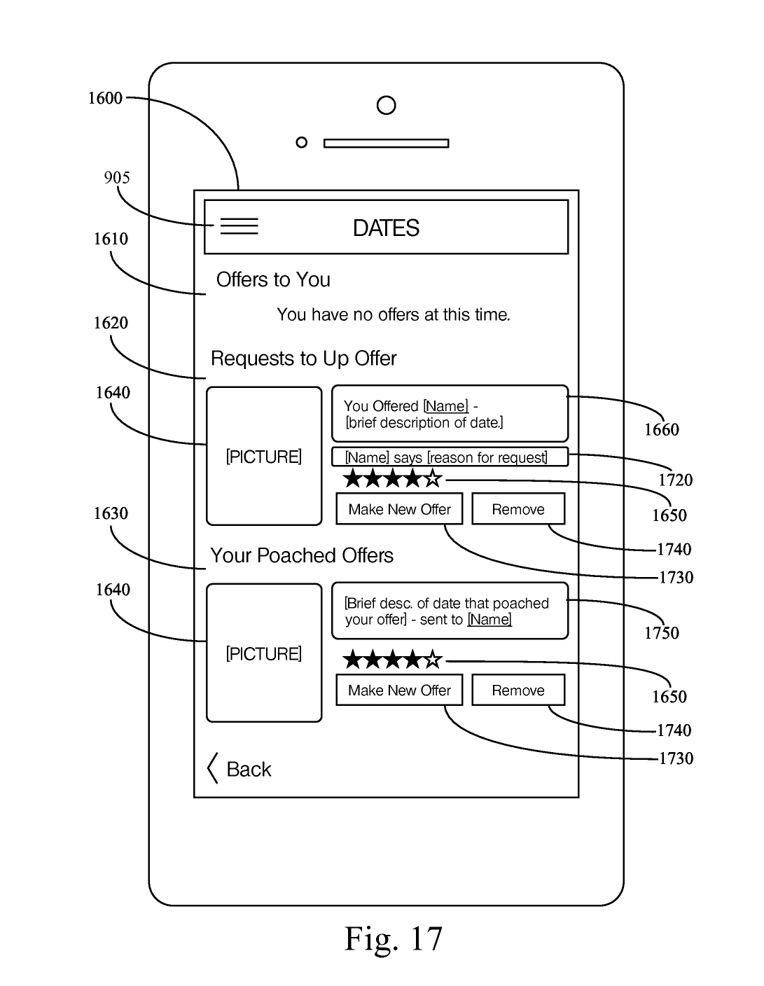

FIGS. 16 and 17 illustrate a mobile computing device showing a date offer screen according to aspects of the subject technology. These screens may be accessed using button 910 shown in FIG. 9. Screen 1600 in FIG. 16 includes “Offers to You” area 1610, “Requests to Up Offer” area 1620, and “Your Poached Offers” area 1630. In the illustrated example, two courtship offers have been made to the user and are described in the “Offers to You” area. The description includes picture 1640 and rating 1650 of the person making the offer. The description also includes the name of the person making the offer and a brief description of the offered date in area 1660.

A proposed time and date for the date is shown in area 1670. The user may accept the offer using accept button 1680, reject the offer using reject button 1690, or request a better offer using “Up Offer” button 1700. In some aspects, the user may also block the person who made the offer using block button 1710. Offers from a blocked person may not be presented to the user, and the current offer from the blocked person may be removed from screen 1600. (Note: References numerals are not included for all like elements in the second description in “Offers to You” area 1610 in order to reduce clutter in the figure.)

Screen 1600 in FIG. 17 shows some variations to the offer descriptions for different types of offers. In FIG. 17, one courtship offer is described in each of “Requests to Up Offer” area 1620 and “Your Poached Offers” area 1630. The description in “Requests to Up Offer” area 1620 differs from the one in area 1610 (shown in FIG. 16) by including a reason for the request for a better offer in area 1720. Also, the description includes button 1730 for the user to make a new courtship offer and button 1740 for the user to remove the description of the offer (i.e., to decide not to make a new offer). The description in “Your Poached Offers” area 1630 differs from the description in “Requests to Up Offer” area 1620 by including a description of an offer for a date that the person accepted over the user's in area 1750.

In some aspects, tapping on picture 1640 and/or some portion(s) of the description of a courtship offer in any of area 1610, 1620, and 1630 may navigate to a profile screen for the person making the offer. In other aspects, swiping across picture 1640 may page through pictures in the profile of the person making the offer. Navigation to a person's profile and/or through the person's pictures in this manner preferably is possible any time an offer is presented to the user.

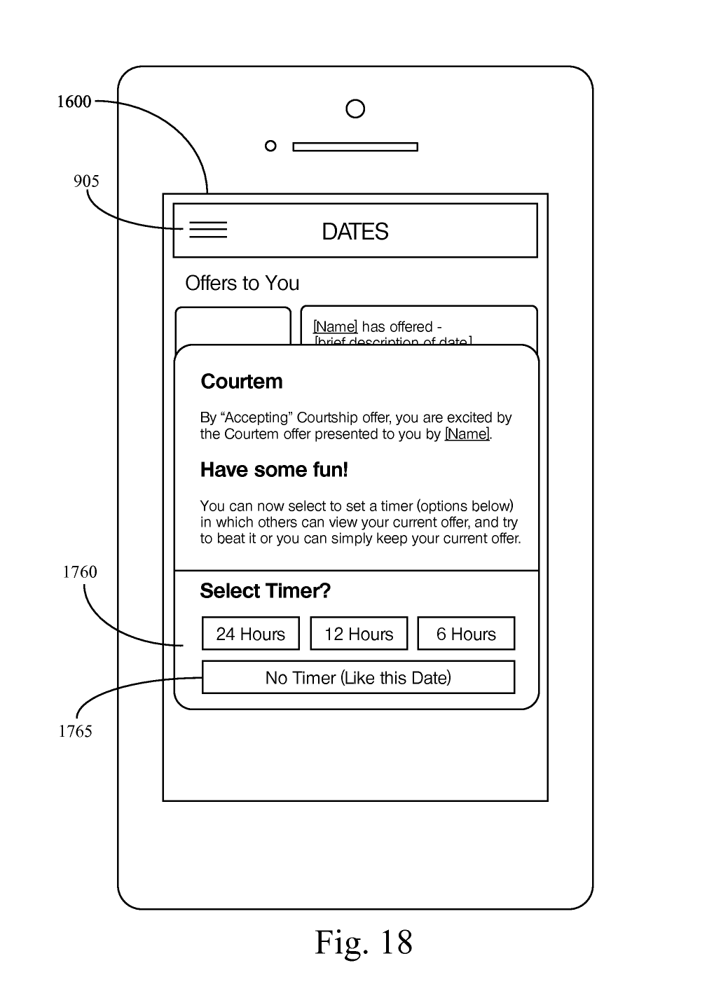

FIG. 18 illustrates a mobile computing device showing a timer selection popup according to aspects of the subject technology. Pop-up 1760 may be displayed when the user accepts a courtship offer for a date. The pop-up requests an indication of whether and for how long the user chooses to allow other people to make competing offers for the date (i.e., attempt to poach the date). Pop-up 1760 permits the user to select a time period for the competing offers using a timer button. In FIG. 18, timer buttons for 6 hours, 12 hours, and 24 hours are shown. In some aspects, different timer buttons or some other mechanism for setting a timer for the competing offers may be used. The user may also choose not to accept competing offers for the accepted date by using “No Timer” button 1765.

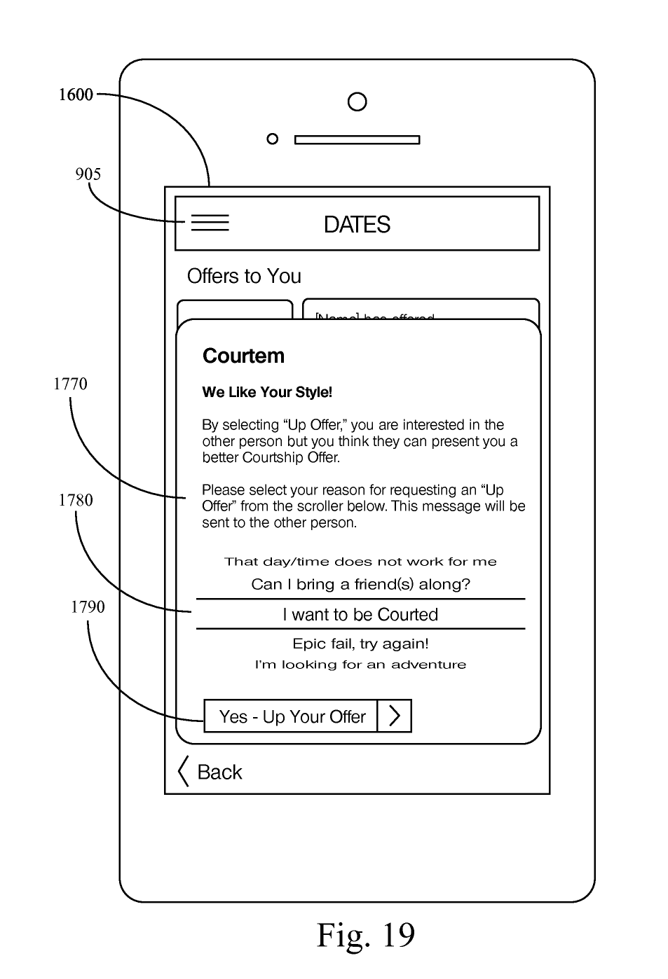

FIG. 19 illustrates a mobile computing device showing an “Up Offer” request popup according to aspects of the subject technology. Pop-up 1770 may be displayed when the user requests that a person make a better courtship offer than one the person has already made. Pre-defined reasons for the request may be shown in scrollable list 1780. The reasons preferably are playful or factual. Possible reasons include but are not limited to the following:
You're cute, but you can do better than that!
That day/time does not work for me
Can I bring a friend(s) along?
I want to be Courted
Epic fail, try again!
I'm looking for an adventure
   Once the user is satisfied with the selected reason, the request for the better courtship offer may be initiated using button 1790.

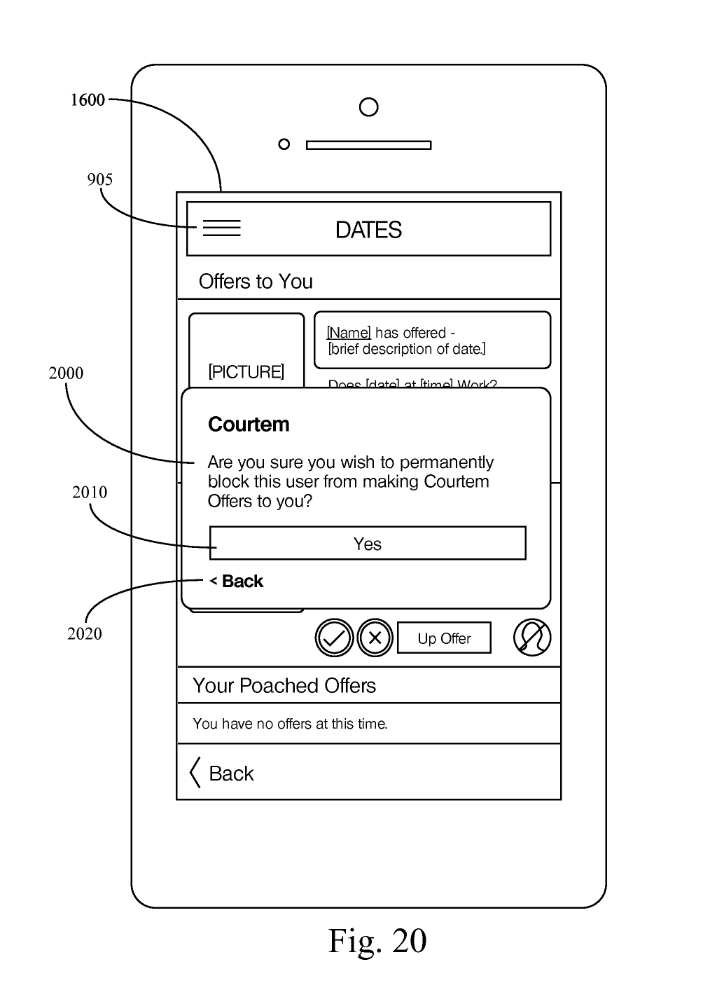

FIG. 20 illustrates a mobile computing device showing a block user confirmation pop-up according to aspects of the subject technology. Pop-up 2000 may be displayed when the user blocks someone. The user may confirm blocking the other person using button 2010 or decline to block the other person using button 2020.

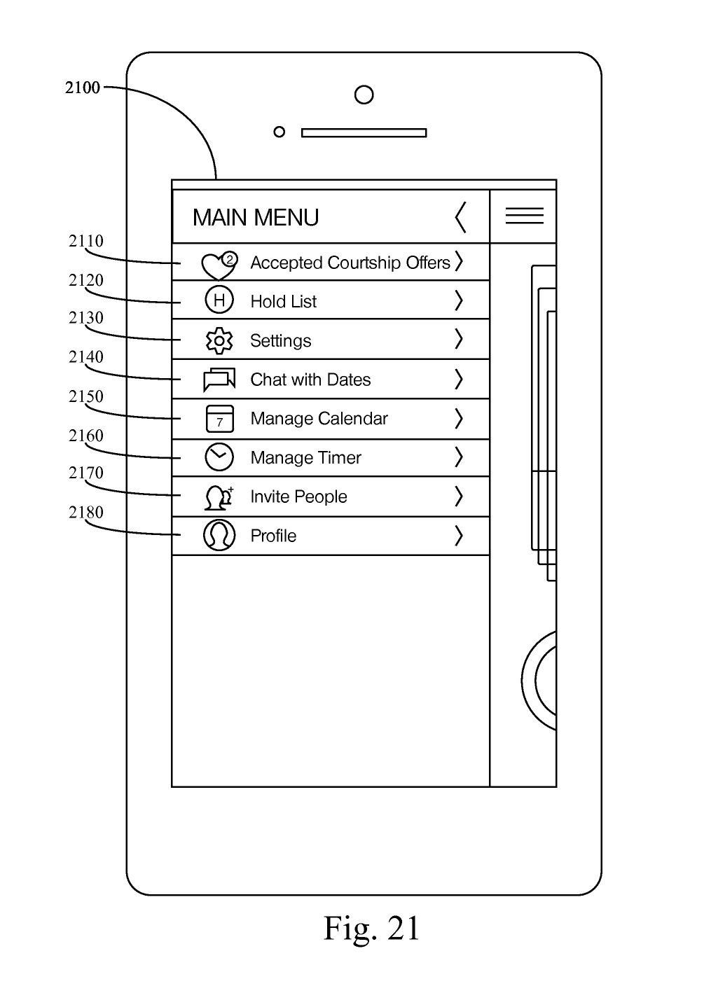

FIG. 21 illustrates a mobile computing device showing a main menu screen according to aspects of the subject technology. Main menu screen 2100 may be accessed from various other screens, for example using menu button 905 (FIG. 9) or via swiping from left to right on screens or portions of screens where such swiping does not have another function. Various screens may be accessed from the main menu screen. The buttons for accessing the screens include “Accepted Courtship Offers” button 2110, “Hold List” button 2120, “Settings” button 2130, “Chat with Dates” button 2140, “Manage Calendar” button 2150, “Manage Timer” button 2160, “Invite People” button 2170, and (user) “Profile” button 2180.

FIG. 22 illustrates a mobile computing device showing an accepted courtship offers screen according to aspects of the subject technology. Screen 2200 in FIG. 22 may be accessed through “Accepted Courtship Offers” button 2110 in FIG. 21 or possibly by tapping menu button 905 (FIG. 9) when the menu button indicates that a courtship offer by the user has been newly accepted. Descriptions 2210 of accepted offers include picture 2220 from the profile of the person who accepted the offer for a date, brief description 2230 of the date, date/time 2240 of the date, and chat button 2250. These elements of description 2210 preferably function substantially as discussed above with respect to various ones of the other figures.

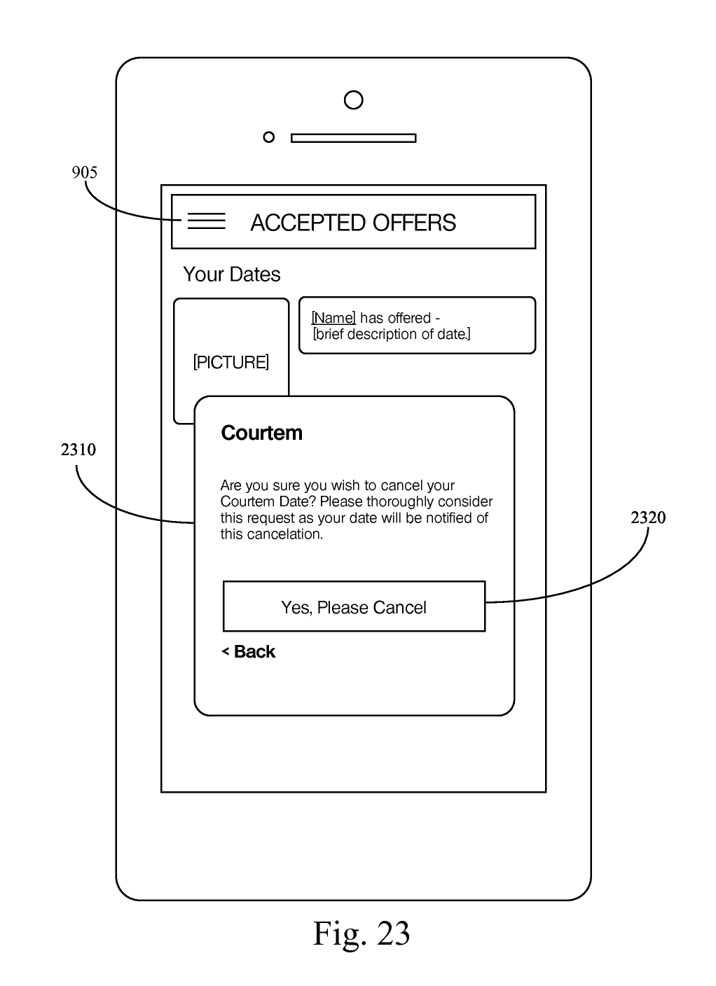

Description 2210 in FIG. 22 also includes timer 2260, which shows how long others may attempt to poach the accepted date. If the timer has expired or the person who accepted the offer did not set a time period for permitting others to poach the date, then timer 2260 may be omitted. Further included in description 2210 is cancel date button 2270. Tapping on the cancel date button may activate a cancel date pop-up, for example as shown in FIG. 23. Pop-up 2310 (FIG. 23) requests confirmation of the cancelation, which may be confirmed using button 2320.

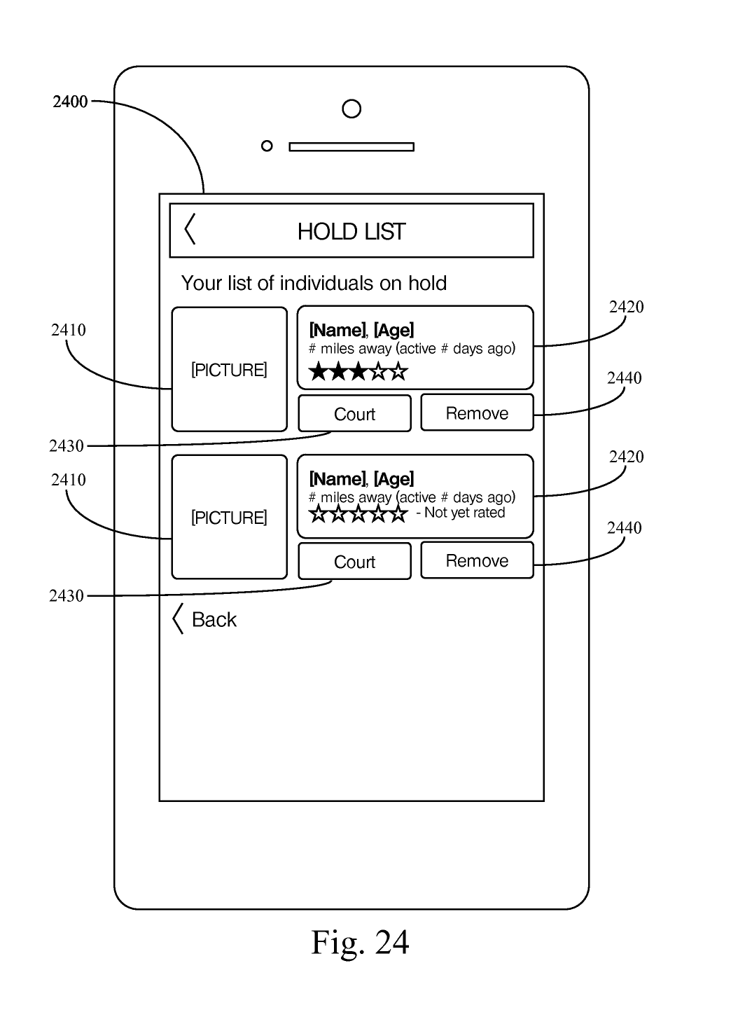

FIG. 24 illustrates a mobile computing device showing a hold list screen according to aspects of the subject technology. Hold list screen 2400 in FIG. 24 may be accessed through “Hold List” button 2120 in FIG. 21. Two held profiles are shown on screen 2400. Picture 2410 and information 2420 are shown for each person. The user may decide to court the person using button 2430 or to remove the person from the hold list using button 2440. In some aspects, tapping on picture 2410 and/or some portion(s) of description 2420 may navigate to a profile screen for the person, and swiping across picture 2410 may page through a person's profile pictures.

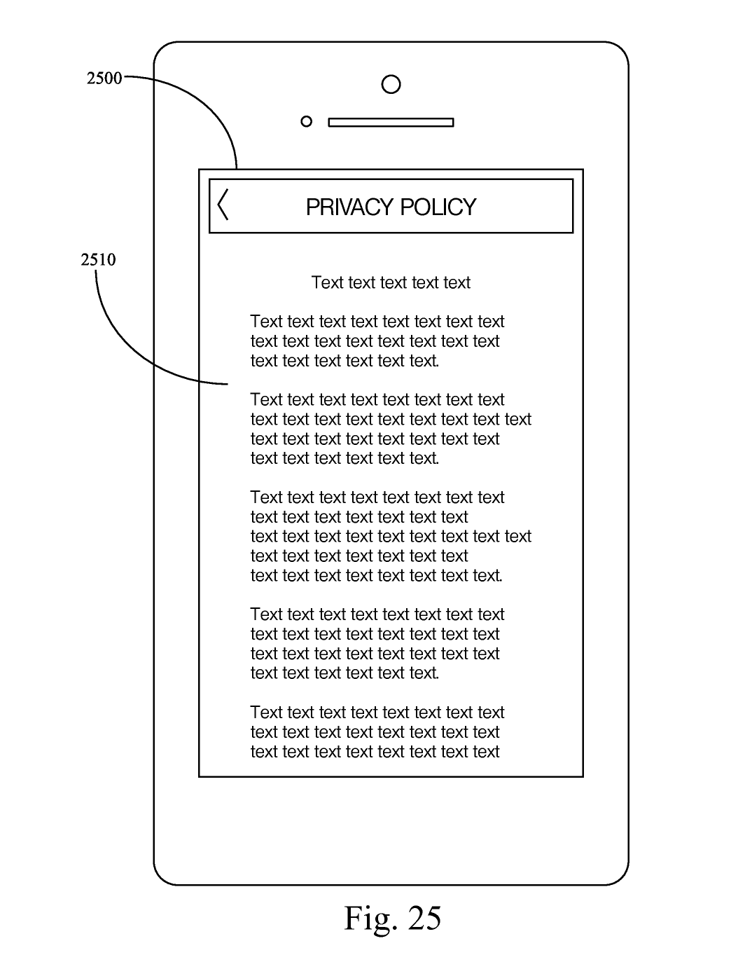

FIG. 25 illustrates a mobile computing device showing privacy policy screen 2500 with privacy policy 2510 according to aspects of the subject technology. A button for exiting the privacy policy screen is located on the top left portion of screen 2500. In some aspects, privacy policy screen 2500 may be accessed from a settings screen, which in turn may be accessed using “Settings” button 2130 in FIG. 21. The settings screen may also permit the user to control other settings, for example time zone, display language, accessibility features, and the like.

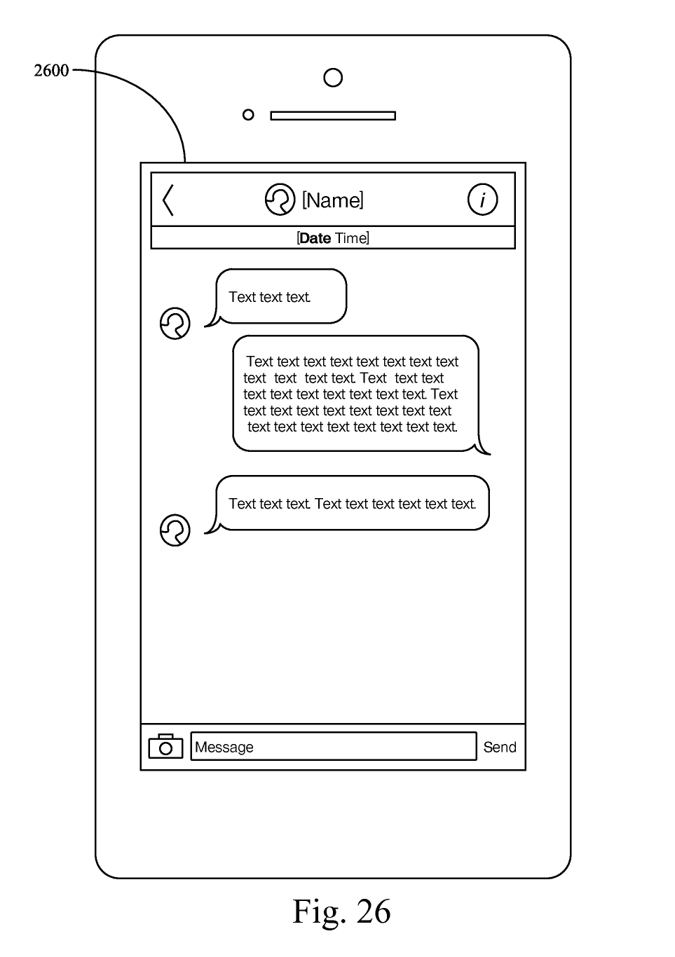

FIG. 26 illustrates a mobile computing device showing a chat screen according to aspects of the subject technology. This screen may be accessed using Chat with Dates button 2140 shown in FIG. 21. In some aspects, chat via screen 2600 may only be enabled once the user and another person have agreed to a courtship offer. Chat may or may not be disabled if the accepted courtship offer is poached. Text chat is show in FIG. 26. In some aspects, other forms of chat such as video chat may be used.

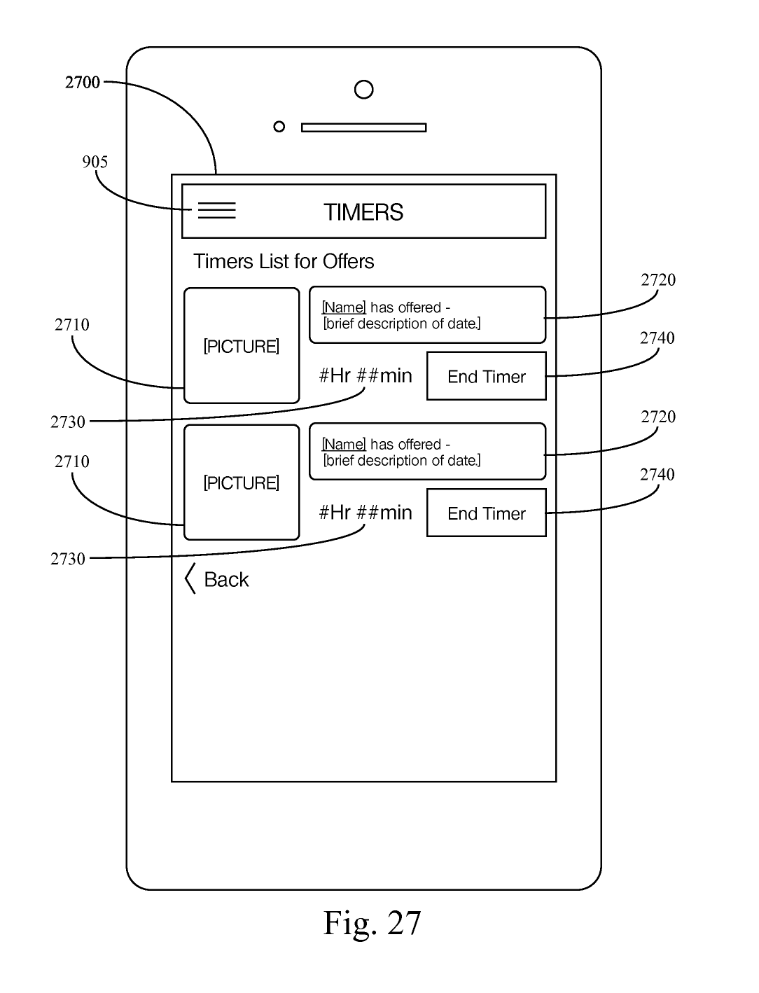

FIG. 27 illustrates a mobile computing device showing a timer management screen according to aspects of the subject technology. This screen may be accessed using Manage Timer button 2160 shown in FIG. 21. The timers represent accepted courtship offers that the user has chosen to allow others to attempt to poach. For each such offer, picture 2710 of the person who made the offer, description 2720 of the offer, and a time remaining 2730 for others to attempt to poach the offer are shown. In some aspects, tapping on one or more of these elements may navigate to a profile screen for the person, and swiping across picture 2710 may page through the person's profile pictures. The user may end a timer using button 2740, in which case others may no longer attempt to poach the offer and the offer may be removed from screen 2700. Alternatively, the offer may also be automatically removed from screen 2700 once the timer has expired.

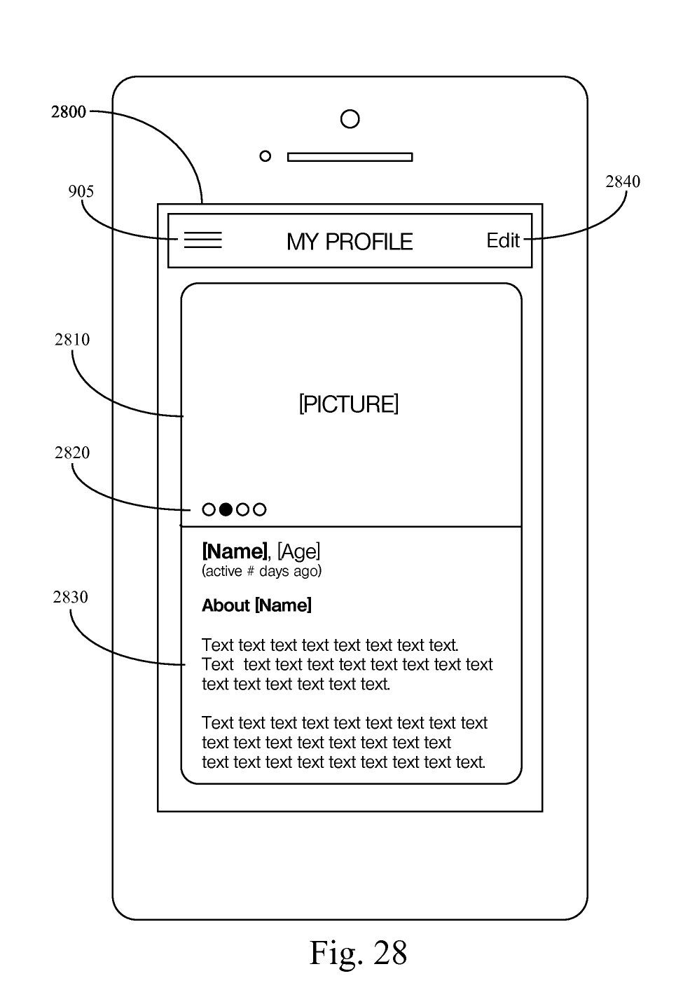

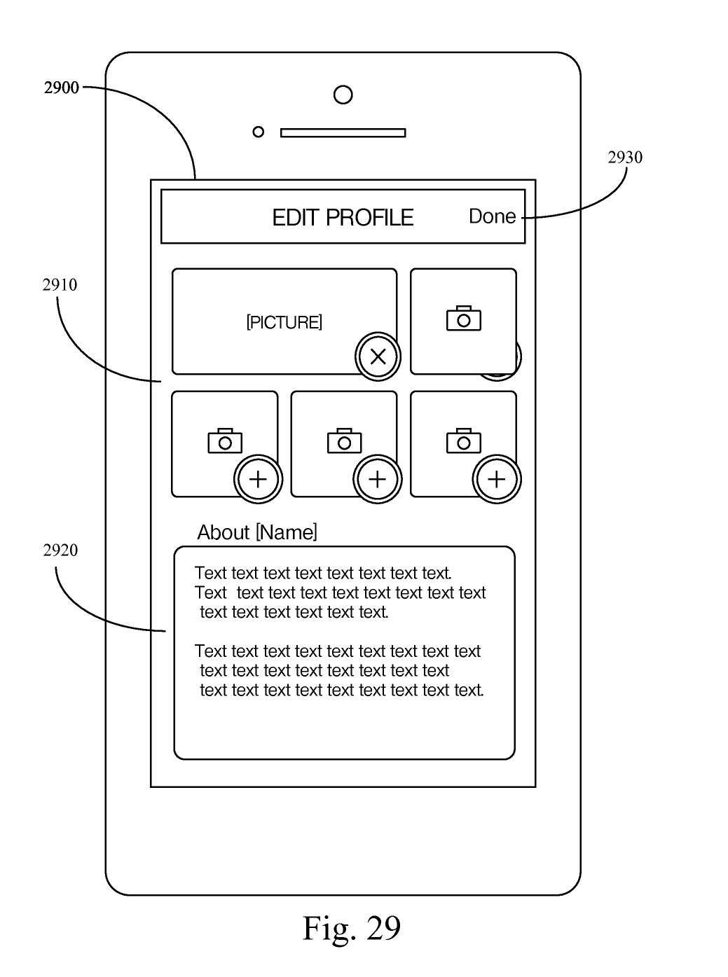

FIG. 28 illustrates a mobile computing device showing a user profile screen according to aspects of the subject technology. This screen may be accessed using (user) Profile button 2180 shown in FIG. 21. Screen 2800 shows profile picture(s) 2810, picture indicator 2820, and profile text 2830. Button 2840 may be used to navigate to an edit profile screen, for example as shown in FIG. 29. Screen 2900 in FIG. 29 includes area 2910 for adding and deleting the user's profile pictures. The user may edit his or her profile text in area 2920. Button 2930 may be used to save changes and exit back to the user's profile.

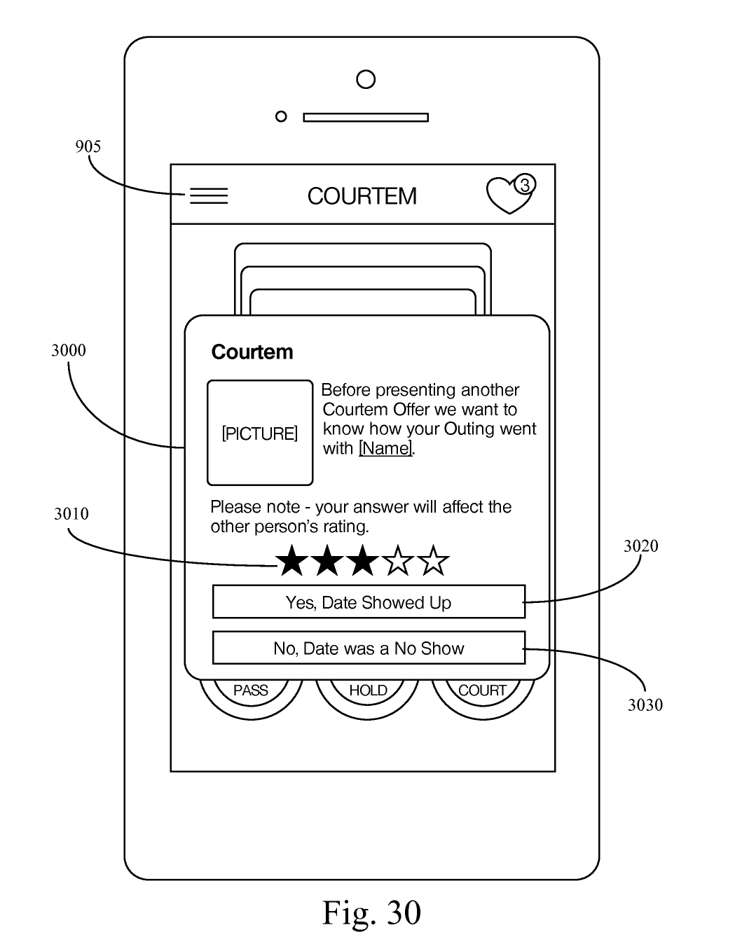

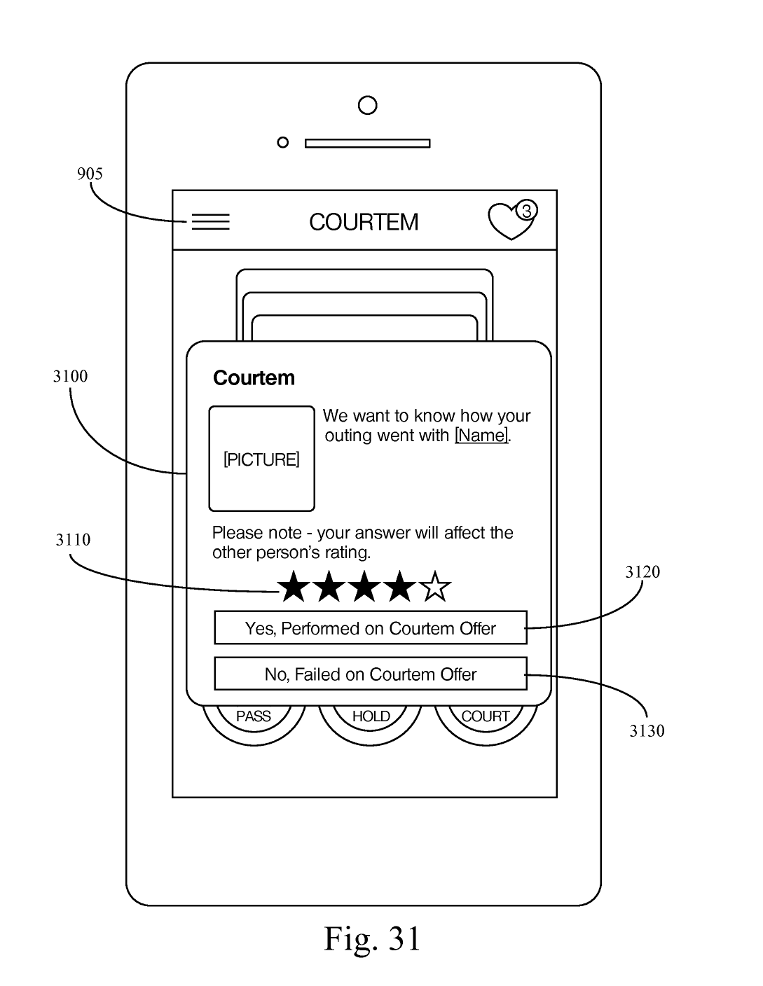

FIGS. 30 and 31 illustrate a mobile computing device showing date rating pop-ups according to aspects of the subject technology. The pop-ups preferably are presented to users some pre-determined time after the time of a date based on an accepted courtship offer. Pop-up 3000 in FIG. 30 may be presented to a person who made a courtship offer for a date that was accepted. The user may select a number of stars representing the user's opinion of the other person's behavior in area 3010. The user may also indicate whether or not the other person showed up for the date using buttons 3020 and 3030. Pop-up 3100 in FIG. 31 may be presented to a person who accepted a courtship offer for a date. The user may select a number of stars representing the user's opinion of the other person's behavior in area 3110. The user may also indicate whether or not the other person performed on his or her courtship offer using buttons 3120 and 3130. The information supplied by the users may be used to modify each user's profile rating, for example via averaging, reducing the rating based on “No” answers, increasing the rating based on “Yes” answers, or in some other manner.

The invention is in no way limited to the specifics of any particular embodiments and examples disclosed herein. For example, the terms “aspect,” “example,” “preferably,” “alternatively” and the like denote features that may be preferable but not essential to include in some embodiments of the invention. For another example, interaction with aspects of the subject technology has been described in terms of touch-screen interactions (e.g., tapping and swiping). However, other forms of interactions such as pointing and clicking may be used. In addition, details illustrated or disclosed with respect to any one aspect of the invention may be used with other aspects of the invention. Additional elements and/or steps may be added to various aspects of the invention and/or some disclosed elements and/or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible which remain within the content, scope and spirit of the invention, and these variations would become clear to those skilled in the art after perusal of this application.

What is claimed is:

1. A method of facilitating courting and dating performed by at least one computing device, comprising:
displaying a courtship offer for a date from a first person to a user;
acquiring from the user an acceptance of the courtship offer, a rejection of the courtship offer, or a request for a better courtship offer; and
transmitting to the first person the acceptance of the courtship offer or the request for a better courtship offer through a communication system or channel.

2. A method as in claim 1, wherein in a case that the user accepts the courtship offer, further comprising acquiring an indication from the user of whether or not the user chooses to permit other people to attempt to submit competing courtship offers for a period of time.

3. A method as in claim 2, wherein in a case that the indication is that the user chooses to permit the other people to submit the competing courtship offers for the period of time, further comprising acquiring an indication of the period of time from the user.

4. A method as in claim 3, wherein in a case that at least one other person submits at least one competing courtship offer during the period of time, further comprising:
displaying the competing courtship offer to the user;
acquiring from the user an acceptance of the competing courtship offer, a rejection of the competing courtship offer, or a request for a better competing courtship offer during the period of time; and
transmitting to the other person the acceptance of the competing courtship offer or the request for a better competing courtship offer through a communication system or channel.

5. A method as in claim 4, wherein in a case that the user accepts the competing courtship offer, further comprising transmitting to the first person an indication that their courtship offer has been poached.

6. A method as in claim 1, further comprising enabling text based chatting between the first person and the user only upon the acceptance of the courtship offer by the user.

7. A method as in claim 1, further comprising engaging a rating system a predetermined time after a time of the date.

8. A method as in claim 7, further comprising determining the time of the date by accessing synced calendars of the user and the first person that indicate the time of the date.

9. A method as in claim 7, wherein engaging the rating system further comprises:
transmitting to the user a request to rate the first person and the user's opinion about the date; and
acquiring from the user a rating of the first person and the user's opinion about the date.

10. A method as in claim 1, wherein in a case that the user requests the better courtship offer, further comprising:
acquiring a reason for the request for the better courtship offer from the user; and
transmitting to the first person the reason through the communication system or channel.

11. A method as in claim 10, wherein acquiring the reason for the request for the better courtship offer further comprises acquiring the reason from a scrolling list of preselected responses.

12. A method of facilitating courting and dating performed by at least one computing device, comprising:
displaying a profile of at least a first person within a geographic area corresponding to a user;
acquiring from the user an indication of an intention to court the first person or not to court the first person;
in a case of the indication of the intention to court the first person, acquiring a courtship offer from the user for a date with the first person;
transmitting the courtship offer from the user to the first person through the communication system or channel;
receiving an acceptance of the courtship offer or a request for a better courtship offer from the first person; and
displaying the acceptance of the courtship offer or the request for a better courtship offer to the user.

13. A method as in claim 12, wherein displaying the profile of the first person further comprises displaying a rating of the first person.

14. A method as in claim 12, wherein in a case that the first person has accepted a prior courtship offer from a second person and has chosen to permit other people to attempt to submit competing courtship offers for a period of time, further comprising displaying the prior courtship offer and a time remaining for the user to submit a competing courtship offer.

15. A method as in claim 12, further comprising enabling text based chatting between the first person and the user only upon the acceptance of the courtship offer by the user.

16. A method as in claim 12, further comprising engaging a rating system a predetermined time after a time of the date.

17. A method as in claim 16, further comprising determining the time of the date by accessing synced calendars of the user and the first person that indicate the time of the date.

18. A method as in claim 16, wherein engaging the rating system further comprises:
transmitting to the user a request to rate the first person and the user's opinion about the date; and
acquiring from the user a rating of the first person and the user's opinion about the date.

19. A method as in claim 12, further comprising:
acquiring an indication that the first person has accepted a competing courtship offer from a second person; and
displaying that the user's courtship offer has been poached.

20. A method as in claim 12, wherein the step of acquiring from the user the indication of the intention to court the first person or not to court the first person further comprises acquiring an indication to hold on deciding to court the first person or not to court the first person.

21. A computing device including at least a tangible computing element, the computing device configured to facilitate courting and dating by performing steps comprising:
displaying a courtship offer for a date from a first person to a user;
acquiring from the user an acceptance of the courtship offer, a rejection of the courtship offer, or a request for a better courtship offer; and
transmitting to the first person the acceptance of the courtship offer or the request for a better courtship offer through a communication system or channel.

22. A computing device as in claim 21, wherein in a case that the user accepts the courtship offer, the steps further comprise acquiring an indication from the user of whether or not the user chooses to permit other people to attempt to submit competing courtship offers for a period of time.

23. A computing device as in claim 22, wherein in a case that the indication is that the user chooses to permit the other people to submit the competing courtship offers for the period of time, the steps further comprise acquiring an indication of the period of time from the user.

24. A computing device as in claim 23, wherein in a case that at least one other person submits at least one competing courtship offer during the period of time, the steps further comprise:
displaying the competing courtship offer to the user;
acquiring from the user an acceptance of the competing courtship offer, a rejection of the competing courtship offer, or a request for a better competing courtship offer during the period of time; and
transmitting to the other person the acceptance of the competing courtship offer or the request for a better competing courtship offer through a communication system or channel.

25. A computing device as in claim 24, wherein in a case that the user accepts the competing courtship offer, the steps further comprise transmitting to the first person an indication that their courtship offer has been poached.

26. A computing device as in claim 21, wherein the steps further comprise enabling text based chatting between the first person and the user only upon the acceptance of the courtship offer by the user.

27. A computing device as in claim 21, wherein the steps further comprise engaging a rating system a predetermined time after a time of the date.

28. A computing device as in claim 27, wherein the steps further comprise determining the time of the date by accessing synced calendars of the user and the first person that indicate the time of the date.

29. A computing device as in claim 27, wherein engaging the rating system further comprises:
transmitting to the user a request to rate the first person and the user's opinion about the date; and
acquiring from the user a rating of the first person and the user's opinion about the date.

30. A computing device as in claim 21, wherein in a case that the user requests the better courtship offer, the steps further comprise:
acquiring a reason for the request for the better courtship offer from the user; and
transmitting to the first person the reason through the communication system or channel.

31. A computing device as in claim 30, wherein acquiring the reason for the request for the better courtship offer further comprises acquiring the reason from a scrolling list of preselected responses.

32. A computing device including at least a tangible computing element, the computing device configured to facilitate courting and dating by performing steps comprising:
displaying a profile of at least a first person within a geographic area corresponding to a user;
acquiring from the user an indication of an intention to court the first person or not to court the first person;
in a case of the indication of the intention to court the first person, acquiring a courtship offer from the user for a date with the first person;
transmitting the courtship offer from the user to the first person through the communication system or channel;
receiving an acceptance of the courtship offer or a request for a better courtship offer from the first person; and
displaying the acceptance of the courtship offer or the request for a better courtship offer to the user.

33. A computing device as in claim 32, wherein displaying the profile of the first person further comprises displaying a rating of the first person.

34. A computing device as in claim 32, wherein in a case that the first person has accepted a prior courtship offer from a second person and has chosen to permit other people to attempt to submit competing courtship offers for a period of time, the steps further comprise displaying the prior courtship offer and a time remaining for the user to submit a competing courtship offer.

35. A computing device as in claim 32, wherein the steps further comprise enabling text based chatting between the first person and the user only upon the acceptance of the courtship offer by the user.

36. A computing device as in claim 32, wherein the steps further comprise engaging a rating system a predetermined time after a time of the date.

37. A computing device as in claim 36, wherein the steps further comprise determining the time of the date by accessing synced calendars of the user and the first person that indicate the time of the date.

38. A computing device as in claim 36, wherein engaging the rating system further comprises:
transmitting to the user a request to rate the first person and the user's opinion about the date; and
acquiring from the user a rating of the first person and the user's opinion about the date.

39. A computing device as in claim 32, wherein the steps further comprise:
acquiring an indication that the first person has accepted a competing courtship offer from a second person; and
displaying that the user's courtship offer has been poached.

40. A computing device as in claim 32, wherein the step of acquiring from the user the indication of the intention to court the first person or not to court the first person further comprises acquiring an indication to hold on deciding to court the first person or not to court the first person.
